(19) United States
(12) Patent Application Publication
(10) Pub. No.: US 2026/0371350 A1
(43) Pub. Date: Nov. 19, 2026

(54) METHOD AND APPARATUS FOR UPLINK AND DOWNLINK TRANSITION IN A COMMUNICATION SYSTEM

(71) Applicant: Electronics and Telecommunications Research Institute, Daejeon (KR)

(72) Inventors: Hoondong NOH, Daejeon (KR); Cheulsoon KIM, Daejeon (KR)

(21) Appl. No.: 19/660,022

(22) Filed: Apr. 27, 2026

(30) Foreign Application Priority Data
Apr. 28, 2025 (KR) 10-2025-0055312
Apr. 8, 2026 (KR) 10-2026-0063381

(51) Int. Cl. H04W 72/21; H04W 24/02

(52) U.S. Cl. CPC H04W 72/21; H04W 24/02

(57) ABSTRACT

A method of a terminal may comprise: receiving, from a base station, configuration information of an uplink (UL) dormancy period in which a default state of a transmitter of the terminal is an OFF state; determining one or more transient periods for uplink transmission within the UL dormancy period; transitioning a state of the transmitter from the OFF state to an ON state in a first transient period among the one or more transient periods, the first transient period being prior to the uplink transmission; and performing the uplink transmission using the transmitter in the ON state.

### CROSS-REFERENCE TO RELATED APPLICATIONS

This application claims priority to Korean Patent Applications No. 10-2025-0055312, filed on Apr. 28, 2025, and No. 10-2026-0063381, filed on Apr. 8, 2026, with the Korean Intellectual Property Office (KIPO), the entire contents of which are hereby incorporated by reference.

### BACKGROUND

### 1. Technical Field

The present disclosure relates to a communication technique, and more particularly, to a technique for transitioning between uplink and downlink directions in a communication system.

### 2. Related Art

A communication system may be designed by considering various service scenarios, service requirements, system compatibility, and the like. In particular, in a 5th generation (5G) new radio (NR) system and a 6th generation radio (6GR) system, not only conventional duplex schemes such as frequency division duplex (FDD) and time division duplex (TDD) but also various operation modes in which transmission and reception characteristics of uplink and downlink are different from each other, such as subband full duplex (SBFD), in-band full duplex (IBFD), multi-transmission and reception points (multi-TRP), and non-terrestrial network (NTN), may be supported.

In a conventional communication system, uplink resources and downlink resources may be configured based on a TDD scheme, and a transient period (e.g., a time duration) in which a downlink transmission power of a base station transitions from an ON state to an OFF state and/or a transient period in which the downlink transmission power of the base station transitions from the OFF state to the ON state may be defined, and technical specifications may be defined such that the transient period is guaranteed by considering an ON state period for transmission of a downlink channel and/or signal during downlink transmission. For a half-duplex (HD) terminal that does not support simultaneous transmission and reception in an FDD band, a transient period for transitioning between uplink and downlink may be defined.

Meanwhile, a transient period of a base station and a terminal is ensured in a simple and uniform manner by a timing advance (TA) offset, an implicit guard period, and/or a D-U collision handling rule for resolving uplink and downlink collisions. Accordingly, in an environment in which uplink communication and downlink communication coexist in a TDD band such as SBFD, IBFD, multi-TRP, or NTN and/or in an environment in which application of multiple TAs is required, optimal communication performance may not be guaranteed. Methods for improving the above-described problems are required.

### SUMMARY

The present disclosure for resolving the above-described problems is directed to providing a method and an apparatus for transitioning between uplink and downlink directions in a communication system.

A method of a terminal, according to exemplary embodiments of the present disclosure, may comprise: receiving, from a base station, configuration information of an uplink (UL) dormancy period in which a default state of a transmitter of the terminal is an OFF state; determining one or more transient periods for uplink transmission within the UL dormancy period; transitioning a state of the transmitter from the OFF state to an ON state in a first transient period among the one or more transient periods, the first transient period being prior to the uplink transmission; and performing the uplink transmission using the transmitter in the ON state.

The method may further comprise: after completing the uplink transmission, transitioning the state of the transmitter from the ON state to the OFF state in a second transient period among the one or more transient periods, the second transient period being after the uplink transmission.

The method may further comprise: after completing the uplink transmission, transitioning the state of the transmitter from the ON state to the OFF state based on no other uplink transmission being present.

The terminal may not perform another uplink transmission within the first transient period.

The method may further comprise: receiving, from the base station, information indicating a configuration for the one or more transient periods, wherein the one or more transient periods may be configured based on an instruction from the base station.

The method may further comprise: performing uplink transmission without configuring a transient period in a normal period in which the default state of the transmitter is the ON state.

The method may further comprise: receiving, from the base station, change information for the one or more transient periods; and updating the one or more transient periods based on the change information.

A method of a base station, according to exemplary embodiments of the present disclosure, may comprise: transmitting, to a terminal, configuration information of a downlink (DL) dormancy period in which a default state of a transmitter of the base station is an OFF state; determining one or more transient periods for downlink transmission within the DL dormancy period; transitioning a state of the transmitter from the OFF state to an ON state in a first transient period among the one or more transient periods, the first transient period being prior to the downlink transmission; and performing the downlink transmission using the transmitter in the ON state.

The method may further comprise: after completing the downlink transmission, transitioning the state of the transmitter from the ON state to the OFF state in a second transient period among the one or more transient periods, the second transient period being after the downlink transmission.

The method may further comprise: after completing the downlink transmission, transitioning the state of the transmitter from the ON state to the OFF state based on no other downlink transmission being present.

The base station may not perform another downlink transmission within the first transient period.

The method may further comprise: transmitting, to the terminal, information indicating the one or more transient periods for the downlink transmission.

The method may further comprise: performing downlink transmission without configuring a transient period in a normal period in which the default state of the transmitter is the ON state.

The method may further comprise: transmitting, to the terminal, change information for the one or more transient periods, wherein the one or more transient periods may be updated based on the change information.

A terminal, according to exemplary embodiments of the present disclosure, may comprise at least one processor, wherein the at least one processor may cause the terminal to perform: receiving, from a base station, configuration information of an uplink (UL) dormancy period in which a default state of a transmitter of the terminal is an OFF state; determining one or more transient periods for uplink transmission within the UL dormancy period; transitioning a state of the transmitter from the OFF state to an ON state in a first transient period among the one or more transient periods, the first transient period being prior to the uplink transmission; and performing the uplink transmission using the transmitter in the ON state.

The at least one processor may further cause the terminal to perform: after completing the uplink transmission, transitioning the state of the transmitter from the ON state to the OFF state in a second transient period among the one or more transient periods, the second transient period being after the uplink transmission.

The at least one processor may further cause the terminal to perform: after completing the uplink transmission, transitioning the state of the transmitter from the ON state to the OFF state based on no other uplink transmission being present.

The at least one processor may further cause the terminal to perform: receiving, from the base station, information indicating a configuration for the one or more transient periods, wherein the one or more transient periods may be configured based on an instruction from the base station.

The at least one processor may further cause the terminal to perform: performing uplink transmission without configuring a transient period in a normal period in which the default state of the transmitter is the ON state.

The at least one processor may further cause the terminal to perform: receiving, from the base station, change information for the one or more transient periods; and updating the one or more transient periods based on the change information.

In a communication system, a flexible method for transitioning between uplink and downlink directions may be provided according to various communication environments such as a duplex scheme, a multi-carrier scheme, a multi-TRP scheme, and a terrestrial network (TN) and/or a non-terrestrial network (NTN). Communication performance can be improved by efficiently supporting direction transition between uplink and downlink even in environments with diverse uplink and downlink transmission and reception characteristics. Stable transmission and reception operations can be supported even when uplink communication and downlink communication coexist in various operation modes. Effects obtainable by the present disclosure may not be limited to the above-described effects. Other effects not mentioned above will be clearly understood by a person having ordinary skill in the art to which the present disclosure pertains based on exemplary embodiments of the present disclosure.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a radio interface protocol structure in a communication system.

FIG. 4 is a conceptual diagram illustrating an exemplary embodiment of time resources in which radio signals are transmitted in a communication system.

FIG. 5 is a conceptual diagram illustrating a time difference between a reception timing of an i-th downlink frame and a transmission timing of an i-th uplink frame in an exemplary embodiment of a communication system.

FIG. 6 is a conceptual diagram illustrating exemplary embodiments of a time/frequency resource grid of a communication system.

FIG. 7 is a conceptual diagram illustrating exemplary embodiments of a synchronization signal and physical broadcast channel (SS/PBCH) block or synchronization signal block (SSB) of a communication system.

FIG. 8 is a conceptual diagram illustrating common delays in an NTN environment.

FIGS. 9A to 9D are conceptual diagrams illustrating various forms of a 3D space communication system.

FIG. 10A is a conceptual diagram illustrating exemplary embodiments of a half-duplex guard period (HD GP) according to terminal capability.

FIG. 10B is a conceptual diagram illustrating exemplary embodiments of an HD GP according to terminal capability.

FIG. 11 is a graph illustrating a change in transmission power during a transition between an ON state and an OFF state.

FIG. 12 is a conceptual diagram illustrating a transition between uplink and downlink based on an SBFD configuration.

FIG. 13 is a conceptual diagram illustrating a transition between uplink and downlink based on an FD configuration.

FIG. 14 is a conceptual diagram illustrating a transient period of a UE transmitter based on the allocation of a UL dormancy period.

FIG. 15 is a conceptual diagram illustrating a transient period of a BS transmitter based on the allocation of a DL dormancy period.

FIG. 16 is a conceptual diagram illustrating a transmitter transient period of a UE or a BS in a multi-carrier operation.

FIG. 17 is a flowchart illustrating an operation of a communication node in a multi-carrier.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In exemplary embodiments of the present application, (re)transmission may mean “transmission,” “retransmission,” or “transmission and retransmission”, (re)configuration may mean “configuration,” “reconfiguration,” or “configuration and reconfiguration”, (re)connection may mean “connection,” “reconnection,” or “connection and reconnection”, and (re)access may mean “access,” “re-access,” or “access and re-access”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g., long-term evolution (LTE) communication network), a 5G communication network (e.g., new radio (NR) communication network), a 6G communication network, or the like. The 4G communication network, 5G communication network, and 6G communication network may be classified as terrestrial networks, when base stations and terminals are all located in terrestrial locations.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

In the present disclosure, “configuration of an operation (e.g., transmission operation)” may refer to signaling of “control information (e.g., information element, parameter) for the operation” and/or “information indicating to perform the operation”. “An information element (e.g., parameter) is configured” may mean that the corresponding information element is signaled. In the present disclosure, signaling may be at least one of system information (SI) signaling (e.g., transmission of a system information block (SIB) and/or master information block (MIB)), RRC signaling (e.g., transmission of RRC parameters and/or higher-layer parameters), MAC control element (CE) signaling, or PHY signaling (e.g., transmission of downlink control information (DCI), uplink control information (UCI), and/or sidelink control information (SCI)). A message for SI signaling may be referred to as an SI message, a message for RRC signaling may be referred to as an RRC message, a message for MAC CE signaling may be referred to as a MAC message, and a message for PHY signaling may be referred to as a PHY message. The above-described messages may be expressed as a first message, a second message, a third message, and the like.

In the present disclosure, a phrase including “when ~” may be expressed as a phrase including “based on ~” or a phrase including “in response to ~”. In other words, a phrase including “when ~” may be interpreted as being identical or similar to a phrase including “based on ~” or a phrase including “in response to ~”.

In the present disclosure, a time may mean a time point, and a time point may mean a time. The terms ‘time’ and ‘time point’ may be used with the same meaning. A reception time of a signal or a channel may mean a reception start time or a reception end time. A transmission time of a signal or a channel may mean a transmission start time or a transmission end time.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to an access terminal, mobile terminal, station, subscriber station, mobile station, portable subscriber station, node, device, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to a node B (NodeB), evolved node B (eNB), 5G node B (gNB), base transceiver station (BTS), radio base station, radio transceiver, access point, access node, road side unit (RSU), digital unit (DU), cloud digital unit (CDU, radio remote head (RRH), radio unit (RU), transmission point (TP), transmission and reception point (TRP), relay node, repeater node, or the like.

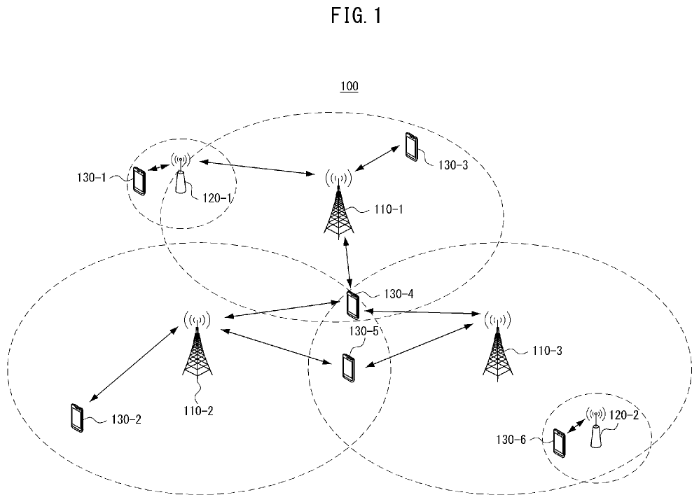

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g., long term evolution (LTE), LTE-advanced (LTE-A)), 5G communication (e.g., new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication nodes may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

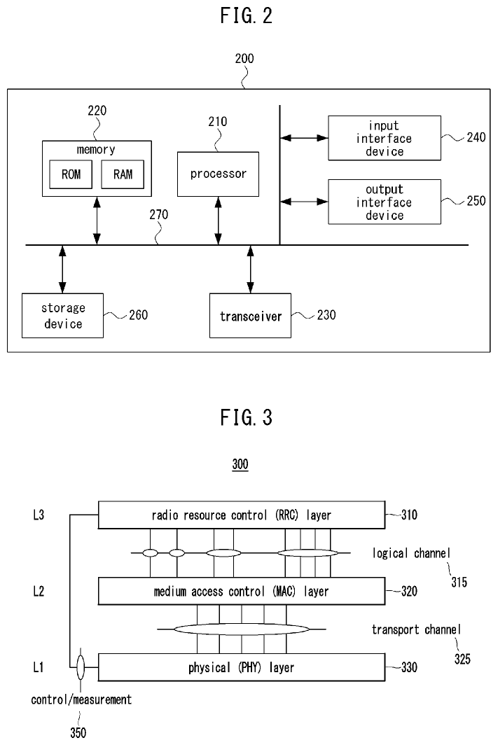

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, or the like. Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

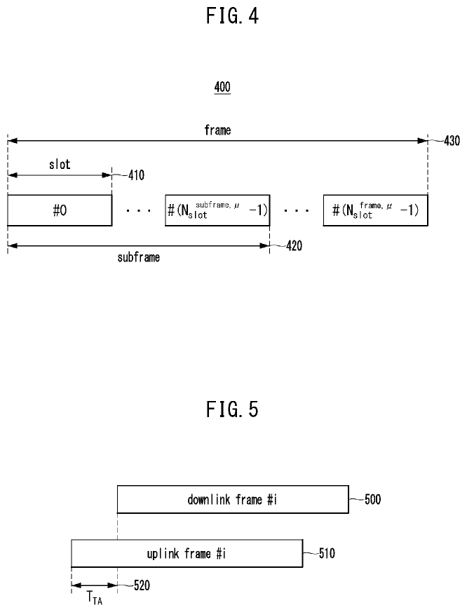

FIG. 3 is a conceptual diagram illustrating exemplary embodiments of a radio interface protocol structure in a communication system.

Referring to FIG. 3, an exemplary embodiment of a radio interface protocol structure 300 of a communication system may be configured to include a radio resource control (RRC) layer 310, a medium access control (MAC) layer 320, a physical (PHY) layer 330, and the like. An exemplary embodiment of the radio interface protocol structure 300 shown in FIG. 3 may correspond to various exemplary embodiments of interfaces such as an interface between a terminal and a base station, an interface between an IAB-node distributed unit (IAB-DU) and an IAB-node mobile terminal (IAB-MT) of an integrated access backhaul (IAB) network, an interface between an IAB-DU and a lower node, an interface between an IAB-MT and an upper node, an interface between a plurality of terminals, and the like.

In the vicinity of the PHY layer 330, the RRC layer 310, and the MAC layer 320, and the like may be disposed above the PHY layer 330. For example, the MAC layer 320 may be disposed above the PHY layer 330. The RRC layer 310 may be disposed above the MAC layer 320.

The MAC layer 320 may be connected to a higher-layer (e.g., RRC layer 310) through logical channels 315. The PHY layer 330 may be connected to the higher MAC layer 320 through transport channels 325. The PHY layer 330 may transmit and receive control information or measurement information 350 to and from the RRC layer 310.

The PHY layer 330 may be referred to as a ‘layer 1’ or ‘L1’. The MAC layer 320 may be referred to as a ‘layer 2’ or ‘L2’. The RRC layer 310 may be referred to as a ‘layer 3’ or ‘L3’. The RRC layer 310 and the MAC layer 320 may be collectively referred to as the ‘higher-layer’.

In the present disclosure, ‘L1 signaling’ refers to signaling such as downlink control information (DCI) transmitted on a physical downlink control channel (PDCCH), uplink control information (UCI) transmitted on a physical uplink control channel (PUCCH), and sidelink control information (SCI) transmitted on a physical sidelink control channel (PSCCH), which are channels of the PHY layer 330. Similarly, in the present disclosure, ‘higher-layer signaling’ may include L2 signaling transmitted through a MAC control element (CE), L3 signaling transmitted through RRC signaling, and the like.

In a communication system to which the 5G communication technology, etc. is applied, one or more of numerologies of Table 1 may be used in accordance with various purposes, such as inter-carrier interference (ICI) reduction according to frequency band characteristics, latency reduction according to service characteristics, and the like.

TABLE 1

| | Δf = 2^{μ} · 15 | |
|---|---|---|
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

Table 1 is merely an example for the convenience of description, and exemplary embodiments of the numerologies used in the communication system may not be limited thereto. Each numerology μ may correspond to information of a subcarrier spacing (SCS) Δf and a cyclic prefix (CP). The terminal may identify a numerology u and a CP value applied to a downlink bandwidth part (BWP) or an uplink BWP based on higher-layer parameters such as subcarrierSpacing, cyclicPrefix, and/or the like.

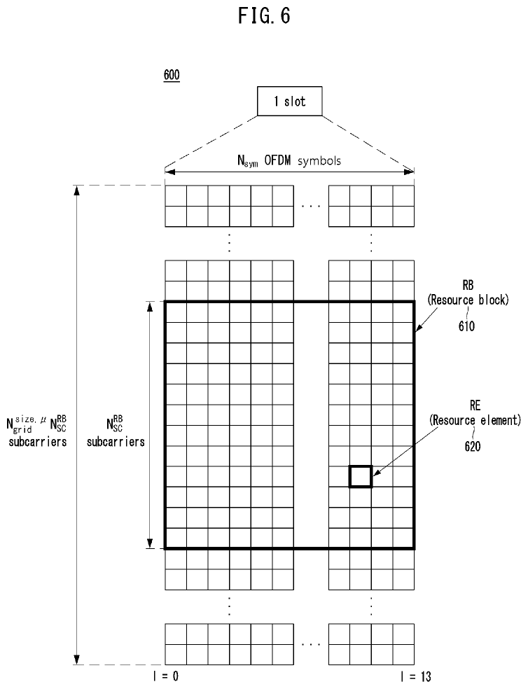

FIG. 4 is a conceptual diagram illustrating an exemplary embodiment of time resources in which radio signals are transmitted in a communication system.

Referring to FIG. 4, time resources in which radio signals are transmitted in a communication system 400 may be represented with a frame 430 comprising one or more

$$( {N}_{slot}^{frame , μ} / {N}_{slot}^{subframe , μ} )$$

subframes, a subframe 420 comprising one or more

$$( {N}_{slot}^{subframe , μ} )$$

slots, and a slot 410 comprising 14

$$( {N}_{symb}^{slot} )$$

OFDM symbols. In this case, according to a configured numerology, as the values of

$${N}_{symb}^{slot} , {N}_{slot}^{sunframe , μ} , and {N}_{slot}^{frame , μ}$$

values according to Table 2 below may be used in case of a normal CP, and values according to Table 3 below may be used in case of an extended CP. The OFDM symbols included within one slot may be classified into ‘downlink’, ‘flexible’, or ‘uplink’ by higher-layer signaling or a combination of higher-layer signaling and L1 signaling.

TABLE 2

| μ | ${N}_{s y m b}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | ${N}_{s y m b}^{slot}$ | ${N}_{slot}^{frame , μ}$ | ${N}_{slot}^{subframe , μ}$ |
|---|---|---|---|
| 2 | 12 | 40 | 4 |

In the NR communication system (e.g., 5G communication system), the frame 430 may have a length of 10 ms, and the subframe 420 may have a length of 1 ms. Each frame 430 may be divided into two half-frames having the same length, and the first half-frame (i.e., half-frame 0) may be composed of subframes #0 to #4, and the second half-frame (i.e., half-frame 1) may be composed of subframes #5 to #9. One carrier may include a set of frames for uplink (i.e., uplink frames) and a set of frames for downlink (i.e., downlink frames).

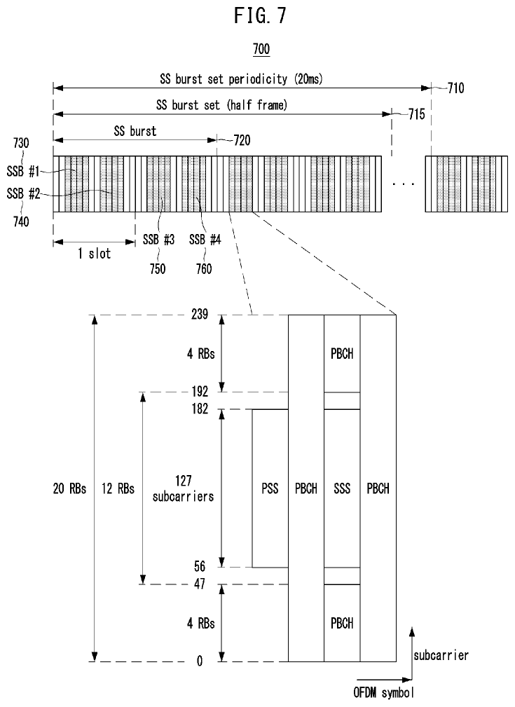

FIG. 5 is a conceptual diagram illustrating a time difference between a reception timing of an i-th downlink frame and a transmission timing of an i-th uplink frame in an exemplary embodiment of a communication system.

Referring to FIG. 5, a time difference between a reception timing of an i-th downlink frame 500 and a transmission timing of an i-th uplink frame 510 may be a T_{TA} 520. Accordingly, the terminal may start transmission of the uplink frame #i 510 at a time earlier by T_{TA} compared to the reception timing of the downlink frame #i 500. T_{TA} may be referred to as a timing advance or timing adjustment TA. The base station may instruct the terminal to change a value of T_{TA} through higher-layer signaling or L1 signaling. For example, T_{TA} may be configured in the base station and/or terminal to be applied in a manner defined as T_{TA}=(N_{TA}+N_{TA,offset})T_{c}. In the case of NR communication system, T_{c} may be defined as

$${T}_{c} = \frac{1}{( Δ {f}_{m ax} \cdot {N}_{f} )} ,$$

may be defined as Δfₘₐₓ=480 kHz, N_{f} may be defined as N_{f}=4096, N_{TA,offset} may be a value set by L3 signaling, and N_{TA} may be a value determined by Equation 1 below by a value T_{A} indicated by L2 signaling.

$$[ Equation 1 ]$$

$${N}_{TA} = \{ \begin{matrix}{T}_{A} \cdot 16 \cdot \frac{64}{{2}^{μ}} & ( for random access response ) \\ {N}_{TA \_ old} + ( ( {T}_{A} - 31 ) \cdot 16 \cdot 64 / {2}^{μ} ) & ( for other cases )\end{matrix}$$

Here, the description on N_{TA,offset} and N_{TA} may be an example for a specific situation, and various other options may exist, but in order not to obscure the gist of the description, all possible cases may not be listed in the present disclosure.

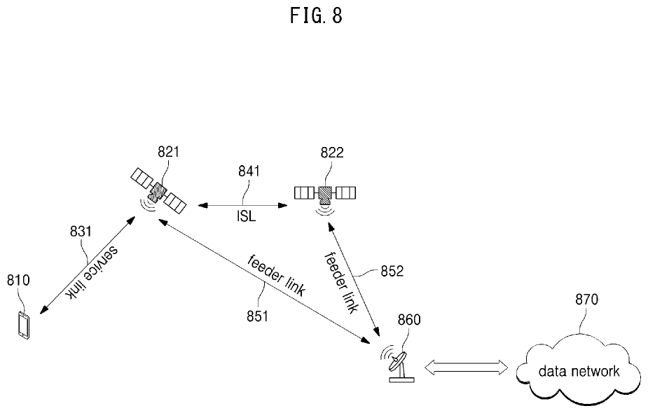

FIG. 6 is a conceptual diagram illustrating exemplary embodiments of a time/frequency resource grid of a communication system.

Referring to FIG. 6, a time/frequency resource grid 600 of a communication system may have

$${N}_{grid}^{size , μ} {N}_{sc}^{RB}$$

subcarriers and

$${N}_{slot}^{subframe , μ}$$

OFDMs. The resource grid may be defined for each numerology and each carrier. In this case,

$${N}_{g r i d}^{start , μ}$$

may mean a position of a common resource block (CRB) indicated by higher-layer signaling.

$${N}_{g r i d}^{size , μ}$$

may mean the number of resource blocks (RBs) starting from the CRB. That is,

$${N}_{g r i d}^{size , μ}$$

may mean a carrier bandwidth.

$${N}_{g r i d}^{start , μ} and / or {N}_{g r i d}^{size , μ}$$

may have different values for each link direction (e.g., uplink, downlink, or sidelink) or for each numerology μ. Here, the numerology u may be referred to by other terms, such as a SCS configuration, if necessary.

Each element in the resource grid for an antenna port p and a SCS configuration μ may be referred to as a resource element (RE) 620. The RE 620 may be uniquely defined for each position (k, l)_{p,μ}. In this case, k may be a frequency axis index, and l may indicate a symbol position on the time axis. RE(k, l)_{p,μ} may correspond to a physical resource used to transmit a physical channel or a signal complex value

$${a}_{k , l}^{( p , μ )} .$$

One RB 610 may be defined as consecutive

$${N}_{s c}^{R B} = 12$$

subcarriers on the frequency axis.

The 5G communication system can use a wider carrier bandwidth as compared with the 3G/4G communication system. The concept of bandwidth part (BWP) may be introduced in order to reduce high implementation complexity and power consumption of terminals due to the widened carrier bandwidth. One BWP may be composed of contiguous CRBs, a starting RB position

$${N}_{B WP , i}^{start , μ}$$

of the BWP and the number

$${N}_{BWP , i}^{s ize , μ}$$

of RBs constituting the BWP may satisfy Equations 2 and 3.

$${N}_{grid , x}^{s t art , μ} \leq {N}_{B WP , i}^{s t a r t , μ} < {N}_{grid , x}^{s t art , μ} + {N}_{g r i d , x}^{size , μ} \qquad [ Equation 2 ]$$

$${N}_{grid , x}^{s t art , μ} < {N}_{B WP , i}^{s t a r t , μ} + {N}_{B WP , i}^{s ize , μ} \cdot \leq {N}_{grid , x}^{s t art , μ} + {N}_{g rid , x}^{s i z e , μ} \qquad [ Equation 3 ]$$

Up to four downlink BWPs within one component carrier (CC) may be configured for a terminal. Only one downlink BWP among the downlink BWPs configured for the terminal may be activated at a time. The terminal may not receive a physical downlink shared channel (PDSCH), a physical downlink control channel (PDCCH), a channel state information reference signal (CSI-RS), or the like outside the activated BWP.

Up to four uplink BWPs within one CC may be configured for a terminal. Only one uplink BWP among the uplink BWPs configured for the terminal may be activated at a time. The terminal may not transmit a physical uplink shared channel (PUSCH), a physical uplink control channel (PUCCH), a sounding reference signal (SRS), or the like outside the activated BWP.

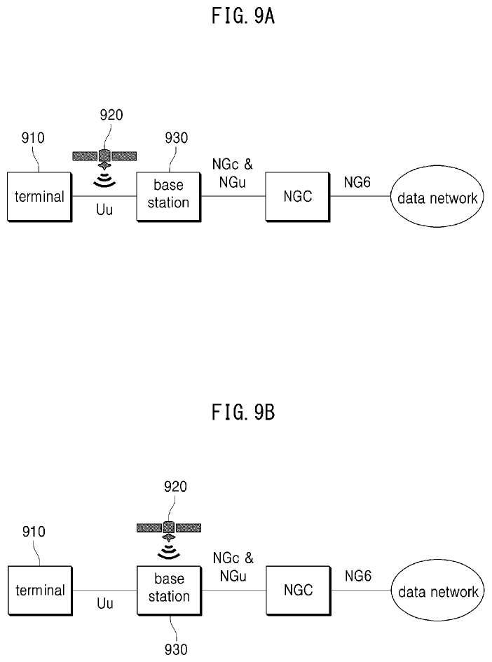

FIG. 7 is a conceptual diagram illustrating exemplary embodiments of a synchronization signal and physical broadcast channel (SS/PBCH) block or synchronization signal block (SSB) of a communication system.

Referring to FIG. 7, an SS/PBCH block 700 of a communication system may be configured with a primary synchronization signal (PSS) transmitted in 127 subcarriers in the middle of a first OFDM symbol, a secondary synchronization signal (SSS) transmitted in 127 subcarriers in the middle of a third OFDM symbol, and a physical broadcast channel (PBCH) transmitted in second, third, and fourth OFDM symbols. The PBCH occupying the widest bandwidth may be transmitted over 20 RBs, which may be 3.6 MHz based on 15 kHz SCS. The base station may transmit one SSB by applying the same beam. When the number of base station antennas increases or it is necessary to operate multiple beams such as applying one or more analog beams for high frequency support, the base station may support multi-beam operations by transmitting multiple SSBs. The term ‘beam’ may be expressed in various terms such as a transmission precoding or a spatial transmission filter. However, in order not to obscure the gist of the description, ‘beam’ is used hereinafter as a unified term.

The base station may transmit a plurality of SSBs 730, 740, 750, and 760 to represent a plurality of beams (e.g., beam #1, beam #2, beam #3, beam #4). In this case, it may be possible that one or more SSBs are transmitted within one slot according to a pattern predetermined according to each numerology. The SSBs 730, 740, 750, and 760 to which different beams are applied may be included in an SS burst 720. In other words, the SSBs 730, 740, 750, and 760 to which different beams are applied may be configured as one group. The terminal may assume a half-frame window having a length of 5 ms at the time of monitoring SSBs. An SS burst set 715 configured by higher-layer signaling within the half-frame window may include one or more SS bursts 720. The terminal may not know RRC configuration value(s) or may not be able to use RRC configuration value(s) in an initial access (IA) procedure. In this case, the terminal may receive or measure the SSBs assuming that a periodicity of the SS burst set 710 is 20 ms.

In the present disclosure, a downlink network structure and an uplink network structure may be independently configured in consideration of a non-terrestrial network (NTN) environment. For example, the downlink network structure and the uplink network structure may be configured differently. Considering the NTN environment, the network structure may be configured independently for each component carrier (CC), carrier group (CG), and/or cell. For example, the network structure may be configured differently for each CC, CG, and/or cell. To compensate for an uplink propagation loss considering the NTN environment, a transmission gain of a relay (or repeater) may be controlled. When the terminal performs dual-connectivity (DC) operations for terrestrial network (TN)-NTN or NTN-NTN, uplink communication (e.g., uplink transmission) may be controlled based on power reduction and/or external power source(s).

When the terminal performs DC operations for TN-NTN or NTN-NTN, power alignment for downlink communication (e.g., downlink receptions) may be requested in order to reduce a dynamic range. In the present disclosure, uplink transmission may refer to uplink communication, and downlink reception may refer to downlink communication. The dynamic range may refer to a power dynamic range. The power dynamic range may refer to a difference between minimum power and maximum power for a specific resource or a difference between a power (e.g., actual power) and an average power for a specific resource. The specific resource may be a resource element (RE), symbol, resource block (RB), subband, carrier, etc. Alternatively, the power dynamic range may refer to a difference between a power (e.g., reception power, transmission power, average power, minimum power, maximum power) for a first network and a power (e.g., reception power, transmission power, average power, minimum power, maximum power) for a second network.

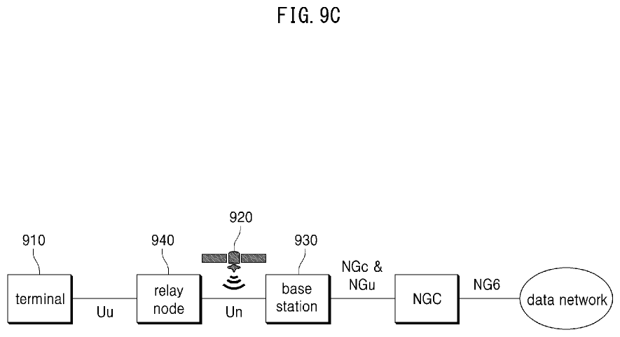

FIG. 8 is a conceptual diagram illustrating common delays in an NTN environment.

Referring to FIG. 8, at least three types of wireless links may exist in the NTN environment (e.g., NTN scenario). The at least three types of wireless links may include a service link 831, an inter-satellite link (ISL) 841, and feeder links 851 and 852. The service link 831 may be a link between a terminal 810 and a satellite 821. The ISL 841 may be a link between the satellites 821 and 822. The feeder links 851 and 852 may be links between a TN 860 connected to a data network 870 and the satellites 821 and 822. The TN 860 may correspond to a gateway on the ground.

The terminal may calculate (e.g., determine) a timing advance (TA) of the terminal based on location information obtained from a global navigation satellite system (GNSS) and/or ephemeris information of a serving satellite. The TA may be determined based on Equation 4 below or Equation 5 below. Equation 4 and Equation 5 may have the same meaning. Variables of Equation 4 and variables of Equation 5 may be cross-referenced. The ephemeris information may be obtained from the serving satellite (e.g., serving base station).

$${T}_{T A} = ( {N}_{T A} + {N}_{T A , UE - specific} + {N}_{TA , common} + {N}_{TA , offset} ) \times {T}_{C} \qquad [ Equation 4 ]$$

$${T}_{T A} = ( {N}_{T A} + {N}_{TA , offset} + {N}_{TA , adj}^{c o m m o n} + {N}_{T A , adj}^{U E} ) {T}_{c} \qquad [ Equation 5 ]$$

N_{TA} may be defined as 0 for a PRACH. N_{TA} may be updated based on a TA command field of Msg2, MsgB, and/or MAC CE. N_{TA,UE-specific} may be used to compensate in advance for a delay on the service link. N_{TA,UE-specific} may be a TA estimated by the terminal itself. N_{TA,common} may be a network-controlled common TA. N_{TA,common} may include a timing offset regarded necessary by the network (e.g., communication network). N_{TA,common} may support a value of 0. N_{TA,offset} may be a fixed offset used to calculate the TA. The terminal may not assume that a round trip time (RTT) between the terminal and the base station is the same as a TA calculated for Msg1/MsgA.

A validity period of the ephemeris information (e.g., satellite ephemeris data) may indicate the maximum time during which the terminal can apply the satellite ephemeris (e.g., existing satellite ephemeris) without acquiring new ephemeris information. The validity period of the ephemeris information may be set by the network. An update procedure of N_{TA} may be performed based on a TA command of Msg2/MsgB and/or a TA command of MAC CE. The update procedure of N_{TA} may be used for alignment (e.g., adjustment, modification, control) of an uplink timing. If a Msg2/MsgB including a TA command (e.g., TA) is received, the terminal may perform a first adjustment (e.g., alignment, modification, control) procedure. N_{TA} may be updated as shown in Equation 6 below.

$${N}_{T A} = {N}_{T A , o l d} + {T}_{A} \cdot 16 \cdot \frac{64}{{2}^{μ}} \qquad [ Equation 6 ]$$

In Equation 6, T_{A} may be indicated by a TA command field included in the Msg2/MsgB. When a MAC CE including a TA command is received, N_{TA} may be updated as shown in Equation 7 below.

$${N}_{TA \_ new} = {N}_{T A , o l d} + ( {T}_{A} - 31 ) \cdot 16 \cdot \frac{64}{{2}^{μ}} \qquad [ Equation 7 ]$$

In Equation 7, T_{A} may be indicated by a TA command field included in the MAC CE. The common TA (e.g., common TA) may include a parameter indicating a timing drift. The terminal may apply the common TA based on the parameter(s) provided by the network. When requirement(s) of an uplink timing error are defined, an offset between the common TA according to the parameter(s) provided by the network and an RTT of the actual feeder link may not be considered.

To improve the timing relationship, a scheduling offset K_{offset} may be introduced. The scheduling offset K_{offset} may be set by system information, and the scheduling offset K_{offset} may be used in an initial access procedure. In this case, a cell-specific K_{offset} used for all beams of at least one cell may be supported. In addition to K_{offset}, a scheduling offset for MAC CE may be defined as K_{mac}.

A downlink frame timing and an uplink frame timing may be aligned at the base station. In this case, K_{mac} may not be needed for operations and/or assumptions of the terminal with respect to downlink and uplink configurations indicated by a MAC CE command transmitted on a PDSCH. On the other hand, a downlink frame timing and an uplink frame timing may not be aligned at the base station. In this case, K_{mac} may be needed for operations and/or assumptions of the terminal with respect to a downlink configuration indicated by a MAC CE command transmitted on a PDSCH, and K_{mac} may not be needed for operations and/or assumptions of the terminal with respect to an uplink configuration indicated by the MAC CE command transmitted on the PDSCH. Information on K_{mac} may be included in system information. In other words, the base station may transmit system information including K_{mac} to the terminal. The terminal may receive the system information from the base station and identify K_{mac} included in the system information.

Update of K_{offset} may be supported after the initial access procedure. By introducing K_{offset} for T_{A} command reception, adjustment (e.g., alignment, modification, control) of an uplink transmission timing may be supplemented. For update of K_{offset} after the initial access procedure, the network (e.g., base station) may provide and/or update a UE-specific K_{offset} using a MAC CE. For the cell-specific K_{offset} set by system information, one of the following two options (e.g., Options 1 and 2) may be selected. Option 1 may be a scheme of signaling one offset value. For example, a value signaled according to Option 1 may include an RTT of the service link and an RTT between the service satellite (e.g., serving satellite) and a reference point. In the present disclosure, the signaling may be at least one of system information (SI) signaling, RRC signaling, MAC CE signaling, or PHY signaling.

Option 2 may be a scheme of signaling two offset values. The two offset values may include a first offset value and a second offset value. K_{offset} may be a sum of the two offset values. The first offset value may be the RTT between the serving satellite and the reference point (or a value determined based on the common TA). The second offset value may be the RTT of the service link. If no K_{offset} other than the value indicated by system information (e.g., K_{offset}) is provided to the terminal, the terminal may apply the value (e.g., K_{offset}) indicated by the system information to improve all timing relationships. The network (e.g., base station) may provide the terminal with K_{mac} for MAC CE, which is a scheduling offset other than K_{offset}. If the network does not provide K_{mac} to the terminal, the terminal may assume K_{mac}=0.

An estimate of a terminal-base station RTT may be equal to a sum of the terminal's TA and K_{mac}. The terminal-base station RTT may refer to an RTT on a link between the terminal and the base station. The ‘terminal-base station RTT’ may refer to the RTT between the terminal and the base station. The TA of the terminal may be determined based on T_{TA}. An estimate of a base station-satellite RTT may be equal to a sum of N_{TA,common}×T_{C} and K_{mac}. The base station-satellite RTT may refer to an RTT in the link between the base station and the satellite. If the network does not provide K_{mac} to the terminal, the terminal may assume K_{mac}=0.

An NTN ephemeris (e.g., ephemeris information) may be divided into ephemeris of the serving cell and ephemeris of neighboring cell(s). Information on when a cell stops local services and/or timing information (e.g., timer and/or absolute time) for a new cell may be supported, at least in an Earth-fixed NTN scenario. Whether both types of ephemeris information (e.g., ephemeris information of the serving cell and ephemeris information of neighboring cell(s)) are required may be identified based on system information and/or ephemeris information.

At least for uplink scheduling adaptation, the terminal may report information on UE-specific TA pre-compensation. While an RA procedure is performed, the terminal may report UE-specific TA pre-compensation to the base station using a MAC CE. If the reporting operation is activated by the network, the terminal may report information on the UE-specific TA pre-compensation to the base station (e.g., network) in the RA procedure using a MAC CE (e.g., transmission procedure of MsgA, transmission procedure of Msg3, and/or transmission procedure of msg5). The information on the UE-specific TA pre-compensation reported in the RA procedure using the MAC CE may be a UE-specific TA. The reporting of the UE-specific TA (e.g., reporting of UE-specific TA pre-compensation) in the RA procedure may be activated/deactivated by system information (SI). The reporting of the UE-specific TA (e.g., reporting information on the UE-specific TA) may be supported in the connected mode (e.g., RRC connected mode). An event trigger scheme may be supported to report information on the UE-specific TA in the connected mode. If a triggering event is configured, the terminal may report information on the UE-specific TA pre-compensation to a target cell in the RA procedure.

If the terminal is not able to report UE location information in the connected mode, the content of the UE-specific TA reported to the base station in the connected mode may be information on the UE-specific TA pre-compensation. If the content of the information on the UE-specific TA reported to the base station is UE location information of the terminal in the connected mode, an RRC signaling may be used to report the UE location information of the terminal (e.g., information on the UE-specific TA). If the terminal is able to report UE location information of the terminal to the base station in the connected mode, for a purpose of TA reporting in the connected mode (e.g., reporting information on the UE-specific TA, reporting UE location information), the network (e.g., base station) may configure the terminal to report the UE-specific TA pre-compensation and/or the UE location information. If the content of the information on the UE-specific TA to be reported in the connected mode to the network is a value of the TA pre-compensation (e.g., UE-specific TA pre-compensation), the terminal may use a MAC CE to report information on the UE-specific TA.

The reporting of the UE location may be performed based on an event-triggering scheme. The reporting of the UE location based on the event-triggering scheme may be configured by the base station to obtain information of updates of the UE location of the terminal in the connected mode (e.g., RRC connected mode). In other words, the base station may transmit configuration information for event-based UE location reporting to the terminal. Periodic UE location reporting may be configured by the base station to obtain information of UE location updates of the terminal in the connected mode (e.g., RRC connected mode).

In order to configure the terminal to report information on the UE-specific TA in a handover procedure, a new indication in RRC reconfiguration with synchronization may not be necessary. The SI (e.g., SIB) may indicate whether information indicating activation or deactivation of the TA reporting (e.g., reporting of information on the UE-specific TA) in the target cell is transmitted through a handover command.

The information on the UE-specific TA pre-compensation may not be reported in an RA procedure triggered according to a request for other SI. The event trigger for reporting information on the UE-specific TA (e.g., UE-specific TA pre-compensation) may be based on the TA value. A TA offset threshold may be used in the event-triggered reporting procedure. At least the TA offset threshold may be a value between a current UE-specific TA value and the last successfully reported UE-specific TA value.

In the quasi-Earth fixed scenario or Earth fixed scenario, timing information on when the cell stops serving the corresponding area may be needed to support cell reselection operations (e.g., NTN cell reselection operations). The base station (e.g., cell, network) may transmit, to the terminal, system information including timing information on when the cell stops services to the corresponding area. The system information may be broadcast. A time at which the cell stops services to the corresponding area may refer to ‘cell stop time’. The operation of broadcasting of information on the cell stop time using an SIB may be applied to quasi-Earth fixed cells. In other words, the operation of broadcasting information on the cell stop time using an SIB may not apply to moving cells. In the quasi-Earth fixed scenario, the timing information on when the cell stops services (e.g., cell stop time) may be used to determine when to perform measurements on neighboring cells. In the quasi-Earth fixed scenario (e.g., quasi-Earth fixed cells), the system information including information on a reference location of the cell (e.g., serving cell and/or neighboring cell) may be broadcast. The reference location may be a center of the cell.

In the quasi-Earth fixed scenario, the terminal may start measuring neighboring cells before the serving cell stops serving the current area. In the quasi-earth fixed scenario, the broadcasted information on the cell stop time (e.g., timing information) may indicate a time when the cell does not cover the current area. ‘The cell does not cover the current area’ may mean that the cell does not provide services for the current area. In the quasi-earth fixed scenario, the terminal may be configured to perform measurements on neighboring cells (e.g., adjacent cells) before the broadcasted stop time of the serving cell (e.g., cell stop time, the time when the cell stops covering the current area). An exact time at which the terminal performs the measurement operation on neighboring cells may be determined depending on an implementation of the terminal.

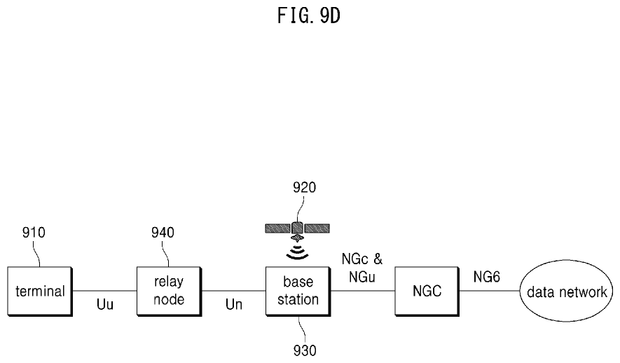

FIGS. 9A to 9D are conceptual diagrams illustrating various forms of a 3D space communication system.

Referring to FIGS. 9A to 9D, a 3D space communication system (e.g., space communication network) may be designed so that a terminal performs wireless communication using a device (e.g., communication node) located in the sky. In the present disclosure, satellites (e.g., 3D space devices) may mean High-Altitude Pseudo Satellites (HPAS), High Altitude Platform Stations (HPAS), Unmanned Aerial Vehicles (UAVs), Urban Air Mobility (UAM), etc. The satellites (e.g., three-dimensional space devices) may not be limited to HPAS, UAVs, and/or UAMs. The satellite may refer to a three-dimensional space device.

In the exemplary embodiment of FIG. 9A, a satellite 920 may relay communication between a terminal 910 and a base station 930. The terminal 910 may be an NTN node (e.g., NTN terminal). The satellite 920 may be a remote radio head (RRH). The satellite 920 may perform a function of relaying Uu radio interface signals between the terminal 910 and the base station 930. An NTN gateway may be included in the base station 930 or the base station 930 itself. In the exemplary embodiment of FIG. 9A, the satellite 920 may relay signals between the terminal 910 and the base station 930, and the satellite 920 may operate transparently. In other words, the satellite 920 may be a transparent-type satellite (i.e., bent-pipe satellite).

In the exemplary embodiment of FIG. 9B, the satellite 920 may support some or all of functions of the base station 930. The satellite 920 may perform functions of a base station or relay node. The satellite 920 may be a satellite base station, and the satellite 920 may directly form (e.g., establish) a Uu link (e.g., Uu radio interface) with terminal 910, and the satellite 920 may be a regenerative-type satellite. In other words, the satellite 920 may support regeneration operations for signals.

In the exemplary embodiment of FIG. 9C, the terminal 910 may form (e.g., establish) a Uu link with a relay node 940. The relay node 940 may be located around the terminal, outdoors, indoors, or on the ground. Alternatively, the relay node 940 may be located within the satellite 920. The relay node 940 may be connected to the base station 930 via the satellite 920. The satellite 920 may be an NTN node. The base station 930 may be a terrestrial base station. The terrestrial base station may refer to a base station located on the ground. The satellite 920 may relay communication between the relay node 940 and the base station 930. The satellite 920 may be an RRH. The satellite 920 may perform a function of relaying Un radio interface signals between the relay node 940 and the base station 930. An NTN gateway may be included in the base station 930 or the base station 930 itself.

In the exemplary embodiment of FIG. 9D, the terminal 910 may form (e.g., establish) a Uu link with the relay node 940. The relay node 940 may be located around the terminal, outdoors, indoors, or on the ground. The base station 930 may be an NTN node. The satellite 920 may support some or all of functions of the base station 930. An Un link may be established between the relay node 940 and the satellite 920 supporting the function(s) of the base station.

In the present disclosure, methods for supporting a reduced capability terminal will be described. The reduced capability terminal may be referred to as a RedCap user equipment (UE). The reduced capability terminal may support half duplex (HD)-frequency division duplex (FDD) operations. The reduced capability terminal supporting HD-FDD operations may be referred to as an HD-FDD RedCap UE, an HD-FDD terminal, or an HD terminal. The reduced capability terminal may access an NTN. In the present disclosure, a terminal may be interpreted as a reduced capability terminal or a general terminal (e.g., legacy terminal) depending on a context.

Methods for supporting an HD-FDD RedCap UE in consideration of an NTN environment will be described. Methods for determining one communication (e.g., one operation) between uplink (UL) communication (e.g., UL transmission operation) and downlink (DL) communication (e.g., DL reception operation) by the HD-FDD RedCap UE in consideration of the NTN environment will be described. Methods for performing the determined one communication (e.g., UL communication or DL communication) will be described. Methods for measuring a channel state, generating channel state information (CSI), and/or reporting CSI by the HD-FDD RedCap UE in consideration of the NTN environment will be described. In a case where a base station indicates, to the terminal, parameters (e.g., K_{offset}, etc.) affecting a preparation time of DL reception processing of the terminal, a preparation time of UL transmission processing of the terminal, a transmission and reception time of a CSI reference signal, and a preparation time of CSI reporting, operations of the terminal according to changes in the aforementioned times will be described. The aforementioned parameters may refer to NTN parameters.

In a communication system (e.g., NR communication system or 5G communication system), a base station (e.g., IAB node or relay) may transmit configuration information of CSI reporting to a terminal or a mobile terminal (MT) using a time and/or frequency resource. The terminal or the MT may receive the configuration information of CSI reporting from the base station. In other words, the base station may control CSI reporting of the terminal or the MT. The relay may support a part or all functions of the base station. The relay may refer to an eNB, a gNB, a base station, an IAB node, an IAB-distributed unit (DU), an IAB-MT, or a repeater. Alternatively, other terms may be used instead of the relay.

The terminal may refer to a UE including a mobile equipment (ME) and a universal mobile telecommunication system (UMTS) subscriber identity module (USIM), an ME including an MT and a terminal equipment (TE), or an MT supporting mobile communication functions. Alternatively, other terms may be used instead of the terminal. The CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), a layer-1 reference resource received power (L1-RSRP), or a layer-1 signal-to-noise and interference ratio (L1-SINR). For CSI reporting, the terminal may receive, through signaling (e.g., higher-layer signaling) from the base station, N reporting configurations (e.g., CSI-ReportConfig), M resource configurations (e.g., CSI-ResourceConfig), and/or a trigger configuration (e.g., CSI-Aperiodic TriggerStateList of CSI-SemiPersistentOnPUSCH-TriggerStateList) including a list of one or more trigger states. Each of N and M may be a natural number.

Each reporting configuration (e.g., CSI-ReportConfig) may include one or more parameters (e.g., one or more higher-layer parameters) defined in Tables 4 to 6 below.

```
TABLE 4
CSI-ReportConfig ::=  SEQUENCE {
    reportConfigId  CSI-ReportConfigId,
    carrier  ServCellIndex  OPTIONAL, -- Need S
    resourcesForChannelMeasurement  CSI-ResourceConfigId,
    csi-IM-ResourcesForInterference  CSI-ResourceConfigId  OPTIONAL, -- Need R
    nzp-CSI-RS-ResourcesForInterference CSI-ResourceConfigId  OPTIONAL, -- Need R
    reportConfigType  CHOICE {
      periodic  SEQUENCE {
        reportSlotConfig  CSI-ReportPeriodicityAndOffset,
        pucch-CSI-ResourceList SEQUENCE (SIZE (1..maxNrofBWPs)) OF PUCCH-CSI-Resource
      },
      semiPersistentOnPUCCH SEQUENCE {
        reportSlotConfig  CSI-ReportPeriodicityAndOffset,
        pucch-CSI-ResourceList SEQUENCE (SIZE (1..maxNrofBWPs)) OF PUCCH-CSI-Resource
      },
      semiPersistentOnPUSCH SEQUENCE {
        reportSlotConfig  ENUMERATED {s15, s110, s120, s140, s180, sl160, s1320},
          reportSlotOffsetList  SEQUENCE  (SIZE  (1..maxNrofUL-Allocations))  OF
INTEGER(0..32),
          p0alpha P0-PUSCH-AlphaSetId
        },
        aperiodic SEQUENCE {
          reportSlotOffsetList  SEQUENCE  (SIZE  (1..maxNrofUL-Allocations))  OF
INTEGER(0..32)
        }
  }
```

TABLE 5

| | |
|---|---|
| reportQuantity | CHOICE { |
| none | NULL, |
| cri-RI-PMI-CQI | NULL, |
| cri-RI-il | NULL, |
| cri-RI-il-CQI | SEQUENCE { |
| | pdsch-BundleSizeForCSI ENUMERATED {n2, n4} OPTIONAL |
| | -- Need S |
| | }, |
| cri-RI-CQI | NULL, |
| cri-RSRP | NULL, |
| ssb-Index-RSRP | NULL, |
| cri-RI-LI-PMI-CQI | NULL |
| }, | |
| reportFreqConfiguration | SEQUENCE { |
| cqi-FormatIndicator | ENUMERATED {widebandCQI, subbandCQI} OPTIONAL, -- Need R |
| pmi-FormatIndicator | ENUMERATED {widebandPMI, subbandPMI} OPTIONAL, -- Need R |
| csi-ReportingBand | CHOICE { |
| subbands3 | BIT STRING(SIZE(3)), |
| . . . | |
| subbands18 | BIT STRING(SIZE(18)), |
| . . . | |
| subbands19-v1530 | BIT STRING(SIZE(19)) |

} OPTIONAL -- Need S

} OPTIONAL -- Need R

```
TABLE 6
  timeRestrictionForChannelMeasurements  ENUMERATED {configured, notConfigured},
  timeRestrictionForInterferenceMeasurements  ENUMERATED {configured, notConfigured},
  codebookConfig  CodebookConfig OPTIONAL, -- Need R
    dummy  ENUMERATED {n1, n2} OPTIONAL, -- Need R
    groupBasedBeamReporting  CHOICE {
      enabled  NULL,
      disabled  SEQUENCE {
        nrofReportedRS  ENUMERATED {n1, n2, n3, n4}
      } OPTIONAL -- Need S
    },
  cqi-Table  ENUMERATED {table1, table2, table3, table4-r17} OPTIONAL, -
- Need R
  subbandSize  ENUMERATED {value1, value2},
  non-PMI-PortIndication  SEQUENCE (SIZE (1..maxNrofNZP-CSI-RS-
ResourcesPerConfig)) OF PortIndexFor8Ranks OPTIONAL, -- Need R
. . .
```

Each resource configuration (e.g., CSI-ResourceConfig) may include one or more parameters (e.g., one or more higher-layer parameters) defined in Table 7 to Table 9 below.

```
TABLE 7
  CSI-ResourceConfig ::=  SEQUENCE {
    csi-ResourceConfigId  CSI-ResourceConfigId,
    csi-RS-ResourceSetList  CHOICE {
      nzp-CSI-RS-SSB  SEQUENCE {
        nzp-CSI-RS-ResourceSetList SEQUENCE (SIZE (1..maxNrofNZP-CSI-RS-
            ResourceSetsPerConfig))  OF  NZP-CSI-RS-ResourceSetId  OPTIONAL, --
Need R
      },
      csi-SSB-ResourceSetList SEQUENCE (SIZE (1..maxNrofCSI-SSB-
            ResourceSetsPerConfig)) OF CSI-SSB-ResourceSetId OPTIONAL -- Need R
    },
    csi-IM-ResourceSetList SEQUENCE (SIZE (1..maxNrofCSI-IM-
          ResourceSetsPerConfig)) OF CSI-IM-ResourceSetId
    },
    bwp-Id  BWP-Id,
    resourceType  ENUMERATED { aperiodic, semiPersistent, periodic },
    . . .
}
```

```
TABLE 8
  NZP-CSI-RS-Resource ::=  SEQUENCE {
    nzp-CSI-RS-ResourceId  NZP-CSI-RS-ResourceId,
    resourceMapping  CSI-RS-ResourceMapping,
    powerControlOffset  INTEGER (−8..15),
    powerControlOffsetSS  ENUMERATED {db-3, db0, db3, db6} OPTIONAL, -- Need R
    scramblingID  ScramblingId,
    periodicity AndOffset  CSI-ResourcePeriodicity AndOffset OPTIONAL, -- Cond
PeriodicOrSemiPersistent
    qcl-InfoPeriodicCSI-RS TCI-Stateld OPTIONAL, -- Cond Periodic
    . . .
}
```

```
TABLE 9
  CSI-IM-Resource ::=  SEQUENCE {
    csi-IM-ResourceId  CSI-IM-ResourceId,
    csi-IM-ResourceElementPattern CHOICE {
      pattern0  SEQUENCE {
        subcarrierLocation-p0 ENUMERATED {s0, s2, s4, s6, s8, s10},
        symbolLocation-p0  INTEGER (0..12)
      },
      pattern1  SEQUENCE {
        subcarrierLocation-p1 ENUMERATED {s0, s4, s8},
        symbolLocation-p1 INTEGER (0..13)
      }
    } OPTIONAL, -- Need M
    freqBand CSI-FrequencyOccupation OPTIONAL, -- Need M
    periodicity AndOffset CSI-ResourcePeriodicity AndOffset OPTIONAL, -- Cond
PeriodicOrSemiPersistent
    . . .
}
```

The trigger configuration (e.g., CSI-AperiodicTriggerStateList or CSI-SemiPersistentOnPUSCH-TriggerStateList) may include one or more parameters (e.g., one or more higher-layer parameters) defined in Table 10 and Table 11 below.

```
TABLE 10
    CSI-MeasConfig ::= SEQUENCE {
      nzp-CSI-RS-ResourceToAddModList SEQUENCE (SIZE (1..maxNrofNZP-CSI-RS-Resources))
OF NZP-CSI-RS-Resource OPTIONAL, -- Need N
      nzp-CSI-RS-ResourceToReleaseList SEQUENCE (SIZE (1..maxNrofNZP-CSI-RS-Resources))
OF NZP-CSI-RS-ResourceId OPTIONAL, -- Need N
      nzp-CSI-RS-ResourceSetToAddModList SEQUENCE (SIZE (1..maxNrofNZP-CSI-RS-
ResourceSets)) OF NZP-CSI-RS-ResourceSet OPTIONAL, -- Need N
      nzp-CSI-RS-ResourceSetToReleaseList SEQUENCE (SIZE (1..maxNrofNZP-CSI-RS-
ResourceSets)) OF NZP-CSI-RS-ResourceSetId OPTIONAL, -- Need N
      csi-IM-ResourceToAddModList SEQUENCE (SIZE (1..maxNrofCSI-IM-Resources)) OF CSI-
IM-Resource OPTIONAL, -- Need N
      csi-IM-ResourceToReleaseList SEQUENCE (SIZE (1..maxNrofCSI-IM-Resources)) OF CSI-IM-
ResourceId OPTIONAL, -- Need N
      csi-IM-ResourceSetToAddModList SEQUENCE (SIZE (1..maxNrofCSI-IM-ResourceSets)) OF
CSI-IM-ResourceSet OPTIONAL, -- Need N
      csi-IM-ResourceSetToReleaseList SEQUENCE (SIZE (1..maxNrofCSI-IM-ResourceSets)) OF
CSI-IM-ResourceSetId OPTIONAL, -- Need N
      csi-SSB-ResourceSetToAddModList SEQUENCE (SIZE (1..maxNrofCSI-SSB-ResourceSets))
OF CSI-SSB-ResourceSet OPTIONAL, -- Need N
  csi-SSB-ResourceSetToReleaseList SEQUENCE (SIZE (1..maxNrofCSI-SSB-ResourceSets)) OF CSI-
SSB-ResourceSetId OPTIONAL, -- Need N
```

```
TABLE 11
  csi-ResourceConfigToAddModList SEQUENCE (SIZE (1..maxNrofCSI-ResourceConfigurations))
OF CSI-ResourceConfig OPTIONAL, -- Need N
    csi-ResourceConfigToReleaseList SEQUENCE (SIZE (1..maxNrofCSI-ResourceConfigurations))
OF CSI-ResourceConfigId OPTIONAL, -- Need N
    csi-ReportConfigToAddModList SEQUENCE (SIZE (1..maxNrofCSI-ReportConfigurations)) OF
CSI-ReportConfig OPTIONAL, -- Need N
    csi-ReportConfigToReleaseList SEQUENCE (SIZE (1..maxNrofCSI-ReportConfigurations)) OF
CSI-ReportConfigId OPTIONAL, -- Need N
    reportTriggerSize INTEGER (0..6) OPTIONAL, -- Need M
    aperiodicTriggerStateList SetupRelease { CSI-AperiodicTriggerStateList } OPTIONAL, -- Need
M
    semiPersistentOnPUSCH-TriggerStateList SetupRelease { CSI-SemiPersistentOnPUSCH-
TriggerStateList } OPTIONAL, -- Need M
    . . . ,
    [[
      reportTriggerSizeDCI-0-2-r16 INTEGER (0..6) OPTIONAL -- Need R
    ]]
}
```

The base station may configure the terminal to derive a CQI based on one table among Tables 12 to 15 below. In other words, the base station may instruct (e.g., configure) the terminal, through signaling, to use one table among Tables 12 to 15 below. The terminal may derive a CQI based on one table among Tables 12 to 15 below according to the configuration of the base station.

TABLE 12

| | | code | |
|---|---|---|---|
| CQI | | rate × | |
| index | modulation | 1024 | efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 13

| | | code | |
|---|---|---|---|
| CQI | | rate × | |
| index | modulation | 1024 | efficiency |
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

TABLE 14

| | | code | |
|---|---|---|---|
| CQI | | rate × | |
| index | modulation | 1024 | efficiency |
| 0 | out of range | | |
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

TABLE 15

| | | code | |
|---|---|---|---|
| CQI | | rate × | |
| index | modulation | 1024 | efficiency |
| 0 | out of range | | |
| 1 | QPSK | 78 | 0.1523 |
| 2 | QPSK | 193 | 0.377 |
| 3 | QPSK | 449 | 0.877 |
| 4 | 16QAM | 378 | 1.4766 |
| 5 | 16QAM | 616 | 2.4063 |
| 6 | 64QAM | 567 | 3.3223 |
| 7 | 64QAM | 666 | 3.9023 |
| 8 | 64QAM | 772 | 4.5234 |
| 9 | 64QAM | 873 | 5.1152 |
| 10 | 256QAM | 711 | 5.5547 |
| 11 | 256QAM | 797 | 6.2266 |
| 12 | 256QAM | 885 | 6.9141 |
| 13 | 256QAM | 948 | 7.4063 |
| 14 | 1024QAM | 853 | 8.3301 |
| 15 | 1024QAM | 948 | 9.2578 |

A combination of a modulation scheme and a transport block (TBS) size satisfying one or more of conditions below may correspond to one CQI index among the CQI indexes in Tables 12 to 15.
Condition 1: indicates a combination of a modulation scheme and a TBS for PDSCH transmission within a CSI reference resource
Condition 2: a modulation scheme is indicated by the CQI index
Condition 3 when combinations of modulation scheme and TBS are applied to the reference resource (e.g., CSI reference resource), only a combination having the smallest TBS among the combinations is considered valid if an effective channel code rate determined based on the combination is closest to a code rate indicated by the CQI index.

In a case where a higher-layer parameter timeRestrictionForChannelMeasurements in a reporting configuration is set to notConfigured, a time-domain measurement restriction may not be applied to channel measurement resources (CMRs) of the reporting configuration. In the above-described situation, when the terminal performs channel measurement for calculating CSI (e.g., CSI value) to be reported in a slot n (e.g., uplink slot n), the terminal may determine (e.g., calculate, derive, obtain) the CSI in consideration of CSI reference resource(s) among non-zero power (NZP) CSI-RS resource(s) included in the CMRs and/or NZP CSI-RS resource(s) located prior to the resource(s) (e.g., the NZP CSI-RS resource(s) or the CSI reference resource(s)

In a case where a higher-layer parameter timeRestrictionForChannelMeasurements in a reporting configuration is set to Configured, a time-domain measurement restriction may be applied to CMRs of the reporting configuration. In the above-described situation, when the terminal performs channel measurement for calculating CSI (e.g., CSI value) to be reported in a slot n (e.g., uplink slot n), the terminal may determine (e.g., calculate, derive, obtain) the CSI in consideration of CSI reference resource(s) among NZP CSI-RS resource(s) included in the CMRs and/or the most recent NZP CSI-RS resource(s) located prior to the resource(s) (e.g., the NZP CSI-RS resource(s) or the CSI reference resource(s)).

In a case where a higher-layer parameter timeRestrictionForChannelMeasurements in a reporting configuration is set to notConfigured, a time-domain measurement restriction may not be applied to interference measurement resources (IMRs) of the reporting configuration. In the above-described situation, when the terminal performs interference measurement for calculating CSI (e.g., CSI value) to be reported in a slot n (e.g., uplink slot n), the terminal may determine (e.g., calculate, derive, obtain) the CSI in consideration of CSI reference resource(s) among CSI-IM resource(s) and/or NZP CSI-RS resource(s) included in the IMRs and/or resource(s) located prior to the resource(s) (e.g., the IMRs, the CSI-IM resource(s), the NZP CSI-RS resource(s), or the CSI reference resource(s)).

In a case where a higher-layer parameter timeRestrictionForChannelMeasurements in a reporting configuration is set to Configured, a time-domain measurement restriction may be applied to IMRs of the reporting configuration. In the above-described situation, when the terminal performs interference measurement for calculating CSI (e.g., CSI value) to be reported in a slot n (e.g., uplink slot n), the terminal may determine (e.g., calculate, derive, obtain) the CSI in consideration of CSI reference resource(s) among CSI-IM resource(s) and/or NZP CSI-RS resource(s) included in the IMRs and/or the most recent resource(s) located prior to the resource(s) (e.g., the IMRs, the CSI-IM resource(s), the NZP CSI-RS resource(s), or the CSI reference resource(s)). The most recent resource may mean the most recent occasion.

A CSI reference resource in a serving cell may be defined as follows.
In the frequency domain, the CSI reference resource may be defined as a downlink PRB group of a band related to the derived CSI (e.g., determined CSI).
In the time domain, the CSI reference resource for CSI to be reported in the slot n (e.g., uplink slot n) may be defined as a downlink slot of Equation 8 below.

$$n - {n}_{CS \_ ref} - {K}_{offset} \cdot \frac{{2}^{{μ}_{D L}}}{{2}^{{μ}_{{K}_{offset}}}} \qquad [ Equation 8 ]$$

In Equation 8, n_{CS_ref}, K_{offset}, 2^{μ}^{_{DL}}, and

$${2}^{{μ}_{{K}_{offset}}}$$

may be configured (e.g., indicated) to the terminal through signaling (e.g., higher-layer signaling, RRC signaling, MAC CE signaling) by the base station. The terminal may identify the above-described parameter(s) through signaling from the base station. Alternatively, the base station and/or the terminal may determine (e.g., derive, obtain) n_{CS_ref}, K_{offset}, 2^{μ}^{_{DL}},

$${2}^{{μ}_{{K}_{offset}}}$$

based on a preconfigured rule. For example, the base station may transmit an RRC configuration and/or a MAC CE including K_{offset} to the terminal.

In a case where a single CSI-RS resource or a single SSB resource is configured as a CMR for periodic CSI reporting or semi-persistent CSI reporting, the terminal may determine n_{CS_ref} as the minimum value indicating a valid uplink slot among integers greater than or equal to 4·2^{μ}^{_{DL}}. In a case where multiple CSI-RS resources or multiple SSB resources are configured as CMRs for periodic CSI reporting or semi-persistent CSI reporting, the terminal may determine n_{CS_ref} as the minimum value indicating a valid uplink slot among integers greater than or equal to 5·2^{μ}^{_{DL}}.

For aperiodic CSI reporting instructed to be transmitted in the same slot where a CSI request based on DCI is received, the terminal may determine n_{CS_ref} such that the slot where the CSI request is received is determined as a valid downlink slot. For aperiodic CSI reporting other than the above-described aperiodic CSI reporting, the terminal may determine n_{CS_ref} as the smallest integer satisfying a separately defined delay requirement Z′. The terminal may perform channel measurement or interference measurement based on periodic or semi-persistent CSI-RS/CSI-IM/SSB, and may transmit an aperiodic CSI report to the base station based on a result of the channel measurement or the interference measurement. In the above-described situation, in a case where the last symbol (e.g., last OFDM symbol) of the periodic or semi-persistent CSI-RS/CSI-IM/SSB resource is within the delay requirement Z′ from the first symbol (e.g., first OFDM symbol) in which the aperiodic CSI report is transmitted, the terminal may not perform a measurement operation on the periodic or semi-persistent CSI-RS/CSI-IM/SSB resource. In other words, in a case where the number of symbols belonging to an interval from the last symbol of the periodic or semi-persistent CSI-RS/CSI-IM/SSB resource to the first symbol in which the aperiodic CSI report is transmitted is not equal to or greater than Z′ symbols, the terminal may not perform a measurement operation on the periodic or semi-persistent CSI-RS/CSI-IM/SSB resource. Z′ may be a natural number.

A slot satisfying condition(s) within a serving cell may be considered (e.g., regarded, determined) as a valid downlink slot. In a case where a valid downlink slot for a CSI reference resource of a CSI reporting configuration does not exist within the serving cell, the terminal may omit CSI reporting for the serving cell in a slot n′ (e.g., uplink slot n′).

In a case where the terminal is configured to report a CQI, the terminal may assume the following item(s) in order to derive (e.g., obtain, determine) the CQI, RI, and/or PMI within a CSI reference resource. Alternatively, the item(s) for deriving (e.g., obtaining, determining) the CQI, RI, and/or PMI may not be limited to the following item(s).
Item 1: The first two symbols (e.g., the first two OFDM symbols) are used for control signal transmission.
Item 2: The number of symbols for PDSCH and DMRS transmission is 12.
Item 3: The same BWP, subcarrier spacing (SCS), and/or CP length as those configured for PDSCH reception.
Item 4: The same bandwidth as a bandwidth configured for CQI reporting
Item 5: No RE usage for SSB, NZP CSI-RS, and/or ZP CSI-RS
Item 6: Redundancy version (RV) 0
Item 7: A ratio between a PDSCH energy per resource element (EPRE) and a CSI-RS EPRE is based on a higher-layer configuration value (e.g., Pc,powerControlOffset).
Item 8: For a DMRS pattern, maxLength and/or dmrs-AdditionalPosition in with DMRS-DownlinkConfig is referenced.
Item 9: No DMRS exists within PDSCH symbols.
Item 10: A PRB bundling size is assumed to be two PRBs.
Item 11: A PDSCH signal transmitted on PDSCH antenna ports [1000, . . . , 1000+v−1] for v layers satisfies a relationship of Equation 8 with respect to a signal transmitted on CSI-RS antenna ports [3000, . . . , 3000+P−1]. W(i) is a precoding matrix indicated by the PMI (e.g., precoding matrix0), and P is the number of CSI-RS ports in the CSI-RS resource. Each of v and P may be a natural number.

Each CSI report may have a priority (e.g., priority value) based on rule(s) described in Tables 16 to 18 below. A lower value may correspond to a higher priority, and a higher value may correspond to a lower priority. In a case where different CSI reports conflict with each other, the different CSI reports may be merged into one CSI report according to a configuration of the base station. Alternatively, among the different CSI reports, one CSI report may be selected, and the remaining CSI reports may be dropped. In a CSI report selection procedure, CSI content may be adjusted according to a CSI payload by referring to the priority value. In the CSI report selection procedure, one CSI report may be selected based on the priority values.

TABLE 16

CSI reports are associated with a priority value Pri_{iCSI} (y, k, c, s) = 2 · N_{cells} · Mₛ · y + N_{cells} · Mₛ ·

k + Mₛ · c + s where

| | |
|---|---|
| | y = 0 for aperiodic CSI reports to be carried on PUSCH y = 1 for semi-persistent CSI reports to be |
| | carried on PUSCH, y = 2 for semi-persistent CSI reports to be carried on PUCCH and y = 3 for periodic |
| | CSI reports to be carried on PUCCH; |
| • | k = 0 for CSI reports carrying L1-RSRP or L1-SINR and k = 1 for CSI reports not carrying L1- |
| | RSRP or L1-SINR; |
| • | c is the serving cell index and N_{cells} is the value of the higher-layer parameter maxNrofServingCells; |
| • | s is the reportConfigID and Mₛ is the value of the higher-layer parameter maxNrofCSI- |
| | ReportConfigurations. |

A first CSI report is said to have priority over second CSI report if the associated Pri_{tCS1} (y, k, c, s) value is
lower for the first report than for the second report.

TABLE 17

Two CSI reports are said to collide if the time occupancy of the physical channels scheduled to carry

the CSI reports overlap in at least one OFDM symbol and are transmitted on the same carrier. When a UE is
configured to transmit two colliding CSI reports,

| | |
|---|---|
| • | if y values are different between the two CSI reports, the following rules apply except for the case w |
| | hen one of the y value is 2 and the other y value is 3 |
| | . The CSI reports may be transmitted on PUSCH or PUCCH. |
| • | The CSI report with higher Pri_{tCS1} (y, k, c, s) value shall not be sent by the UE. |

otherwise, the two CSI reports are multiplexed or either is dropped based on the priority values, as described
in Clause 9.2.5.2 in [6, TS 38.213].

```
TABLE 18
  If a semi-persistent CSI report to be carried on PUSCH overlaps in time with PUSCH data
transmission in one or more symbols on the same carrier, and if the earliest symbol of these PUSCH
channels starts no earlier than N_{2+d2,1} symbols after the last symbol of the DCI scheduling the PUSCH
where d_{2,1} is the maximum of the d_{2,1} associated with the PUSCH carrying semi-persistent CSI report
and the PUSCH with data transmission, the CSI report shall not be transmitted by the UE. Otherwise, if
the timeline requirement is not satisfied this is an error case.
  If a UE would transmit a first PUSCH that includes semi-persistent CSI reports and a second
PUSCH that includes an UL-SCH and the first PUSCH transmission would overlap in time with the
second PUSCH transmission, the UE does not transmit the first PUSCH and transmits the second
PUSCH. The UE expects that the first and second PUSCH transmissions satisfy the above timing
conditions for PUSCH transmissions that overlap in time when at least one of the first or second PUSCH
transmissions is in response to a DCI format detection by the UE.
```

The terminal may transmit a terminal capability report (e.g., UE capability report) to the base station. The base station may receive the terminal capability report from the terminal. Terminal capability information may include information on the maximum number of CSI calculations that the terminal can perform simultaneously.

In a case where the terminal starts calculations for N CSI reports while L CSI processing units (CPUs) are occupied at the terminal, the terminal may not perform updates for (N−M) CSI reports having lower priorities based on the above-described priority description. The state where L CPUs are occupied may refer to a state where L CPUs are used for CSI report calculations. Each of L, N, and M may be a natural number. M may be the largest positive number within a range greater than or equal to 0 and less than or equal to N among values satisfying Equation 9 below.

$${O}_{C P U}^{( n )}$$

may be the number of CPUs used for the n-th CSI calculation.

$${\sum }_{n = 0}^{M - 1} {O}_{C P U}^{( n )} \leq {N}_{C P U} - L \qquad [ Equation 9 ]$$

A number of CPUs required for each CSI report may be determined based on Table 19 to Table 23 below.

```
TABLE 19
Processing of a CSI report occupies a number of CPUs for a number of symbols as follows:
O_{CPU} = 0 for a CSI report with CSI-ReportConfig with higher-layer parameter reportQuantity set to
‘none’ and CSI-RS-ResourceSet with higher-layer parameter trs-Info configured
  O_{CPU} = 1 for a CSI report with CSI-ReportConfig with higher-layer parameter reportQuantity set to
‘cri-RSRP’, ‘ssb-Index-RSRP’, ‘cri-SINR’, ‘ssb-Index-SINR’ or ‘none’ (and CSI-RS-ResourceSet with higher-
layer parameter trs-Info not configured)
  for a CSI report with CSI-ReportConfig with higher-layer parameter reportQuantity set to ‘cri-RI-
PMI-CQI’, ‘cri-RI-il’, ‘cri-RI-il-CQI’, ‘cri-RI-CQI’, or ‘cri-RI-LI-PMI-CQI’,
  if max{ μPDCCH, μCSI-RS, μUL} ≤ 3, and if a CSI report is aperiodically triggered without
transmitting a PUSCH with either transport block or HARQ-ACK or both when L = 0 CPUs are occupied,
where the CSI corresponds to a single CSI with wideband frequency-granularity and to at most 4 CSI-RS ports
in a single resource without CRI report and where codebookType is set to ‘typeI-SinglePanel’ or where
reportQuantity is set to ‘cri-RI-CQI’, O_{CPU} = N_{CPU}.
```

```
TABLE 20
  If a CSI-ReportConfig is configured with codebookType set to ‘typeI-SinglePanel’ and the
corresponding CSI-RS Resource Set for channel measurement is configured with two Resource Groups and N
Resource Pairs, O_{CPU} = 2N + M, where M is defined in technical specifications.
  otherwise, O_{CPU} = Kₛ, where Kₛ is the number of CSI-RS resources in the CSI-RS resource set for
channel measurement.
  For a CSI report with CSI-ReportConfig with higher-layer parameter reportQuantity not set to ‘none’,
the CPU(s) are occupied for a number of OFDM symbols as follows:
  A periodic or semi-persistent CSI report (excluding an initial semi-persistent CSI report on PUSCH
after the PDCCH triggering the report) occupies CPU(s) from the first symbol of the earliest one of each CSI-
RS/CSI-IM/SSB resource for channel or interference measurement, respective latest CSI-RS/CSI-IM/SSB
occasion no later than the corresponding CSI reference resource, until the last symbol of the configured
PUSCH/PUCCH carrying the report.
```

```
TABLE 21
    An aperiodic CSI report occupies CPU(s) from the first symbol after the PDCCH triggering the CSI
report until the last symbol of the scheduled PUSCH carrying the report. When the PDCCH candidates are
associated with a search space set configured with searchSpaceLinking, for the purpose of determining the
CPU occupation duration, the PDCCH candidate that ends later in time among the two linked PDCCH
candidates is used.
    An initial semi-persistent CSI report on PUSCH after the PDCCH trigger occupies CPU(s) from the
first symbol after the PDCCH until the last symbol of the scheduled PUSCH carrying the report. When the
PDCCH candidates are associated with a search space set configured with searchSpaceLinking, for the purpose
of determining the CPU occupation duration, the PDCCH candidate that ends later in time among the two
linked PDCCH candidates is used.
    For a CSI report with CSI-ReportConfig with higher-layer parameter reportQuantity set to 'none' and
CSI-RS-ResourceSet with higher-layer parameter trs-Info not configured, the CPU(s) are occupied for a
number of OFDM symbols as follows:
    A semi-persistent CSI report (excluding an initial semi-persistent CSI report on PUSCH after the
PDCCH triggering the report) occupies CPU(s) from the first symbol of the earliest one of each transmission
occasion of periodic or semi-persistent CSI-RS/SSB resource for channel measurement for L1-RSRP
$computation , until {Z}_{3}^{′} symbols after the last symbol of the latest one of the CSI - RS / SSB resource for channel$
measurement for L1-RSRP computation in each transmission occasion.
```

```
TABLE 22
    An aperiodic CSI report occupies CPU(s) from the first symbol after the PDCCH triggering the CSI
report until the last symbol between Z₃ symbols after the first symbol after the PDCCH triggering the CSI
$report and {Z}_{3}^{′} symbols after the last symbol of the latest one of each CSI - RS / SSB resource for channel$
measurement for L1-RSRP computation.
    $where ( {Z}_{3} , {Z}_{3}^{′} ) are defined in technical specifications .$
    In any slot, the UE is not expected to have more active CSI-RS ports or active CSI-RS resources in
active BWPs than reported as capability. NZP CSI-RS resource is active in a duration of time defined as
follows. For aperiodic CSI-RS, starting from the end of the PDCCH containing the request and ending at the
end of the scheduled PUSCH containing the report associated with this aperiodic CSI-RS. When the PDCCH
candidates are associated with a search space set configured with searchSpaceLinking, for the purpose of
determining the NZP CSI-RS resource active duration, the PDCCH candidate that ends later in time among the
two linked PDCCH candidates is used.
```

TABLE 23
For semi-persistent CSI-RS, starting from the end of when the activation command is applied, and
ending at the end of when the deactivation command is applied. For periodic CSI-RS, starting when the periodic
CSI-RS is configured by higher-layer signalling, and ending when the periodic CSI-RS configuration is
released. If a CSI-RS resource is referred N times by one or more CSI Reporting Settings, the CSI-RS resource
and the CSI-RS ports within the CSI-RS resource are counted N times. For a CSI-RS Resource Set for channel
measurement configured with two Resource Groups and N Resource Pairs, if a CSI-RS resource is referred X
times by one of the M CSI-RS resources, where M is defined in technical specifications, and/or one or two
Resource Pairs, the CSI-RS resource and the CSI-RS ports within the CSI-RS resource are counted X times.

Various factors including elements below may be assumed as specific values, and CSI reported in a slot n (e.g., uplink slot n) may be derived (or determined, obtained) based on the assumptions. Alternatively, the CSI reported in the slot n may be determined in consideration of the specific values. In the present disclosure, elements assumed by the terminal to generate CSI may be referred to as CSI components. The CSI components may be defined as shown in Table 24 below. The CSI components may not be limited to the elements described in Table 24 below. In other words, the CSI components may include various elements other than those described in Table 24.

TABLE 24
- Frequency-domain positions of the CSI reference resources
- Time-domain positions of the CSI reference resources
- Positions of valid downlink slots
- Transmission/measurement positions of CMRs/IMRs (e.g., satisfaction of minimum delay requirement)
- Priority of each CSI
- Number of CPUs used for each CSI calculation
- Maximum number of CPUs supported by the terminal
- Number of currently occupied CPUs
- CSI reporting indication/activation status
- Whether multi-TRP CSI calculation is performed
- Downlink power control configuration values (e.g., powerControlOffset)
- Discontinuous reception (DRX) configuration

The communication system (e.g., LTE communication system, NR communication system, or 6G communication system) may include different types of terminals having transmission and reception capabilities for various types of radio signals. The terminal may report capability (e.g., capability characteristics) of the terminal to the base station based on an initial access procedure (e.g., initial access (IA) procedure) and/or a terminal capability reporting procedure. The base station may receive information on the capability of the terminal from the terminal.

In the communication system (e.g., LTE communication system, NR communication system, or 6G communication system), the terminal may transmit information indicating that the terminal is a reduced capability terminal (e.g., RedCap UE) to the base station during at least one of an initial access procedure or a terminal capability reporting procedure. The base station may identify the type of the terminal (e.g., reduced capability terminal) based on the information received from the terminal.

The reduced capability terminal may include an HD FDD terminal that does not support simultaneous operations for UL communication (e.g., UL transmission) and DL communication (e.g., DL reception) in a paired spectrum of a communication system supporting frequency division duplex (FDD).

In a case where uplink transmission is allocated to an uplink frequency resource and downlink reception is allocated to a downlink frequency resource within the same time duration, the HD-FDD terminal (e.g., reduced capability terminal) may determine an operation to be performed and an operation not to be performed based on a prioritization rule.

In a case where an operation of the HD-FDD terminal transitions from an uplink transmission operation to a downlink reception operation or transitions from a downlink reception operation to an uplink transmission operation, a guard period (GP) may be applied between time resources for transition between the operations (e.g., switching between the operations).

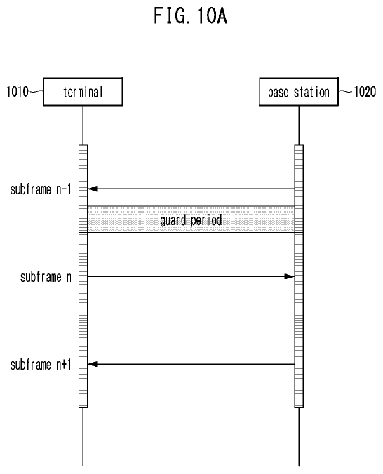

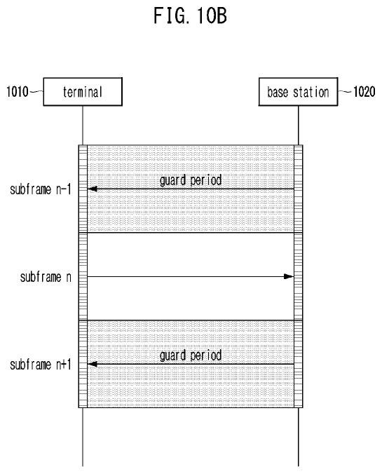

FIG. 10A is a conceptual diagram illustrating exemplary embodiments of a half-duplex guard period (HD GP) according to terminal capability.

Referring to FIG. 10A, a GP (e.g., HD GP) may be configured as one or more OFDM symbols (e.g., a duration within several microseconds or several tens of microseconds) based on the capability of the terminal. In FIG. 10A, the GP may be a type A HD-FDD GP.

FIG. 10B is a conceptual diagram illustrating exemplary embodiments of an HD GP according to terminal capability.

Referring to FIG. 10B, a GP (e.g., HD GP) may be configured as one or more slots (e.g., a duration within several milliseconds or several tens of milliseconds) based on the capability of the terminal. In FIG. 10B, the GP may be a type B HD-FDD GP.

Within a time duration corresponding to the GP, it may be guaranteed that a terminal 1010 does not perform an uplink transmission operation to a base station 1020 and/or a downlink reception operation from the base station 1020.

A method for determining a UL/DL operation for the HD-FDD terminal supported by the communication system may be based on Tables 25 to 28 below. A method for determining a UL/DL operation for the HD-FDD terminal may not be limited to the exemplary embodiments defined in Tables 25 to 28. According to the method for determining a UL/DL operation, one operation among an uplink transmission operation (e.g., UL communication) and a downlink reception operation (e.g., DL communication) may be selected. A UL/DL operation for the HD-FDD terminal may be determined based on an HD-FDD prioritization rule. In the present disclosure, the HD-FDD terminal may be referred to as an HD terminal or an HD UE for convenience. The HD-FDD prioritization rule may be referred to as an HD prioritization rule. Alternatively, the HD-FDD prioritization rule may simply be referred to as a prioritization rule for convenience.

The HD terminal may not be able to perform an uplink transmission operation and a downlink reception operation simultaneously in a paired spectrum within a serving cell. The HD terminal may predict downlink reception within a symbol set and may not perform an uplink transmission operation within the symbol set. The symbol set may include one or more symbols. For example, the HD terminal may receive at least one of a PDCCH, PDSCH, CSI-RS, or DL-positioning reference signal (DL-PRS) within a symbol set configured by higher-layer parameter(s). In other words, a symbol set for a downlink reception operation may be configured to the terminal based on higher-layer signaling (e.g., higher-layer parameter(s)) from the base station. In a case where at least one transmission among a PUCCH, PUSCH, PRACH, or SRS is not instructed to the HD terminal within a symbol set based on DCI, the terminal may receive a downlink signal/channel within the symbol set. In a case where at least one transmission among a PUCCH, PUSCH, PRACH, or SRS is instructed to the HD terminal within a symbol set based on DCI, the terminal may not receive a downlink signal/channel within the symbol set.

Higher-layer signaling (e.g., higher-layer parameter(s)) of the base station may configure the HD terminal to perform an uplink transmission operation within a symbol set. In a case where DCI instructing reception of a downlink signal/channel is not received within a symbol set, the HD terminal may perform an uplink transmission operation within the symbol set.

In a case where the first symbol of a symbol set occurs within a preset time (e.g., Tproc,2) from the last symbol of PDCCH reception (e.g., DCI reception), the HD terminal may not cancel uplink transmission within the symbol set. The preset time (e.g., Tproc,2) may be determined based on a processing capability of the HD terminal. Alternatively, the preset time (e.g., Tproc,2) may be determined based on factors other than the processing capability of the HD terminal or the processing capability of the HD terminal and other factors.

The HD terminal may select one operation between an uplink transmission operation and a downlink reception operation based on Tables 25 to 28 below. Operations of the HD terminal may not be limited to the exemplary embodiments defined in Tables 25 to 28.

```
TABLE 25
  A half-duplex UE (HD-UE) in paired spectrum is not capable of simultaneous transmissions and receptions
on a serving cell with paired spectrum.
  A HD-UE does not expect to detect a DCI format scheduling a reception in a set of symbols and detect a
DCI format scheduling a transmission in any symbol from the set of symbols.
  When a PDCCH reception by a UE includes two PDCCH candidates from corresponding search space sets,
as described in clause 10.1, the end of the PDCCH reception is the end of the PDCCH candidate that ends later.
  If a HD-UE is configured by higher-layers to receive a PDCCH, or PDSCH, or CSI-RS, or DL PRS in a set
of symbols,
  - the HD-UE receives the PDCCH, or PDSCH, or CSI-RS, or DL PRS if the HD-UE does not detect a DCI
format that indicates to the HD-UE to transmit a PUSCH, or PUCCH, or PRACH, or SRS in at least one symbol
of the set of symbols;
- otherwise, the HD-UE does not receive the PDCCH, or PDSCH, or CSI-RS, or DL PRS in the set of symbols.
```

```
TABLE 26
  If a HD-UE is configured by higher-layers to transmit SRS, or PUCCH, or PUSCH in a set of symbols and
the UE detects a DCI format indicating to the HD-UE to receive CSI-RS or PDSCH in a subset of symbols
from the set of symbols, then
  - the HD-UE does not expect to cancel the transmission of the PUCCH or PUSCH in the set of symbols if
the first symbol in the set occurs within T_(proc,2) relative to a last symbol of a PDCCH reception where the
HD-UE detects the DCI format; otherwise, the HD-UE cancels the PUCCH, or the PUSCH, or an actual
repetition of the PUSCH.
  - the HD-UE does not expect to cancel the transmission of SRS in symbols from the subset of symbols that
occur within T_(proc,2) relative to a last symbol of a PDCCH reception where the HD-UE detects the DCI
format. The HD-UE cancels the SRS transmission in remaining symbols from the subset of symbols.
  - T_(proc,2) is the PUSCH preparation time for UE processing capability 1 assuming d_2,1=1 and μ
corresponds to the smallest SCS configuration between the SCS configuration of the PDCCH carrying the DCI
format and the SCS configuration of the SRS, PUCCH, PUSCH.
  A HD-UE does not expect to receive both dedicated higher-layer parameters configuring transmission in a
set of symbols and dedicated higher-layer parameters configuring reception in the set of symbols.
  A HD-UE does not expect to receive both a Type-0/0A/0B/1/2-PDCCH CSS set configuration for PDCCH
reception in a set of symbols and dedicated higher-layer parameters configuring transmission in the set of
symbols, except Type-2-PDCCH CSS set configuration for PDCCH reception in a set of symbols and
configured-grant based PUSCH transmission in the set of symbols for which case the UE follows the procedure.
  The UE expects to be configured with a Type-2-PDCCH CSS set configuration for PDCCH reception such
that there is at least one paging occasion that does not overlap with configured-grant based PUSCH
transmission as described in clause 19.1 per SI modification period.
```

```
TABLE 27
  If a HD-UE would transmit a PUSCH, or PUCCH, or SRS based on a configuration by higher-layers and the
HD-UE is indicated presence of SS/PBCH blocks within the active DL BWP by ssb-PositionsInBurst in SIB1
or in ServingCellConfigCommon or by NonCellDefiningSSB, the HD-UE does not transmit
  - PUSCH or PUCCH if a last symbol of the PUSCH or PUCCH transmission would not be at least N_{Tx-Rx}·T_{c}
prior to a first symbol of the next earliest SS/PBCH block
  - PUSCH or PUCCH if a first symbol of the PUSCH or PUCCH transmission would not be at least N_{Rx-Tx}·T_{c}
after a last symbol of the previous latest SS/PBCH block
  - SRS in symbols that would not be at least N_{Tx-Rx}·T_{c} prior to a first symbol of the next earliest SS/PBCH
block
  - SRS in symbols that would not be at least N_{Rx-Tx}·T_{c} after a last symbol of the previous latest SS/PBCH
block
  If a HD-UE would transmit a PRACH based on a detected DCI format, or PUSCH, or PUCCH, or SRS and
the HD-UE is indicated presence of SS/PBCH blocks within the active DL BWP by ssb-PositionsInBurst in
SIB1 or in ServingCellConfigCommon or by NonCellDefiningSSB in a set of symbols, the HD-UE does not
transmit PUSCH or PUCCH or PRACH if a transmission would overlap with any symbol from the set of
symbols and the HD-UE does not transmit SRS in the set of symbols.
```

```
TABLE 28
  If a HD-UE would transmit a PRACH or MsgA PUSCH triggered by higher-layers in a set of symbols and
would receive a PDCCH, or a PDSCH, or a CSI-RS, or a DL PRS, or is indicated presence of SS/PBCH blocks
within the active DL BWP by ssb-PositionsInBurst in SIBI or in ServingCellConfigCommon or by
NonCellDefiningSSB in symbols that include any symbol from the set of symbols, the HD-UE can select based
on its implementation whether to either transmit the PRACH or the MsgA PUSCH or receive the PDSCH, or
the CSI-RS, or the PL RS, or the PDCCH, or the SS/PBCH blocks.
  If a HD-UE would receive a PDCCH, or a PDSCH, or a CSI-RS, or a DL PRS based on a configuration by
higher-layers or is indicated presence of SS/PBCH blocks within the active DL BWP by ssb-PositionsInBurst
in SIB1 or in ServingCellConfigCommon or by NonCellDefiningSSB in a set of symbols, and the HD-UE would
transmit PRACH or MsgA PUSCH triggered by higher-layers starting or ending at a symbol that is earlier or
later than N_{Rx-Tx}·T_{c} or N_{Tx-Rx}·T_{c}, respectively, from the last or first symbol in the set of symbols, the HD-UE
can select based on its implementation whether to either transmit the PRACH or the MsgA PUSCH or receive
the PDSCH, or the CSI-RS, or the DL PRS, or the PDCCH, or the SS/PBCH blocks.
```

In Tables 25 to 28, a transition time (e.g., NTx-Rx or NRx-Tx) may be configured for each frequency range (e.g., frequency range 1 (FR1) or frequency range 2 (FR2)). The transition time may be defined as shown in Table 29.

TABLE 29

| Transition time | FR1 | FR2 |
|---|---|---|
| N_{TX-RX} | 25600 | 13792 |
| N_{RX-TX} | 25600 | 13792 |

In a communication system supporting at least one of carrier aggregation (CA), dual connectivity (DC), or multi-connectivity (MC), methods for determining a multi-carrier transmission and reception operation for a terminal not supporting simultaneous transmission and reception operation may be supported. The simultaneous transmission and reception operation may refer to an operation of performing uplink communication and downlink communication simultaneously in a same time duration. The multi-carrier transmission and reception operation may be determined based on a multi-carrier prioritization rule. Table 30 below may define a GP for an HD terminal supporting HD-FDD, HD-CA, and/or HD-DC. The GP may not be limited to the exemplary embodiment described in Table 30. The GP may be determined based on at least one of NTx-Rx and NRx-Tx defined in Table 29.

```
TABLE 30
  A UE not capable of full-duplex communication and not supporting simultaneous transmission and reception
as defined by parameter simultaneousRxTxInterBandENDC, simultaneousRxTxInterBandCA or
simultaneousRxTxSUL among all cells within a group of cells is not expected to transmit in the uplink in one
cell within the group of cells earlier than N_{Rx-Tx} · T_{c} after the end of the last received downlink symbol in the
same or different cell within the group of cells where N_{Rx-Tx} is given.
  A UE not capable of full-duplex communication and not supporting simultaneous transmission and reception
as defined by parameter simultaneousRxTxInterBandENDC, simultaneousRxTxInterBandCA or
simultaneousRxTxSUL among all cells within a group of cells is not expected to receive in the downlink in one
cell within the group of cells earlier than N_{Tx-Rx} · T_{c} after the end of the last transmitted uplink symbol in the
same or different cell within the group of cells where N_{Tx-Rx} is given.
  For DAPS handover operation, a UE not capable of full-duplex communication is not expected to transmit
in the uplink to a cell earlier than N_{Rx-Tx} · T_{c} after the end of the last received downlink symbol in the different
cell where N_{Rx-Tx} is given.
  For DAPS handover operation, a UE not capable of full-duplex communication is not expected to receive in
the downlink from a cell earlier than N_{Tx-Rx} · T_{c} after the end of the last transmitted uplink symbol in the
different cell where N_{Tx-Rx} is given.
  A UE not capable of full-duplex communication is not expected to transmit in the uplink earlier than N_{Rx-Tx} ·
T_{c} after the end of the last received downlink symbol in the same cell where N_{Rx-Tx} is given.
A UE not capable of full-duplex communication is not expected to receive in the downlink earlier than N_{Tx-Rx}·
T_{c} after the end of the last transmitted uplink symbol in the same cell where N_{Tx-Rx} is given.
```

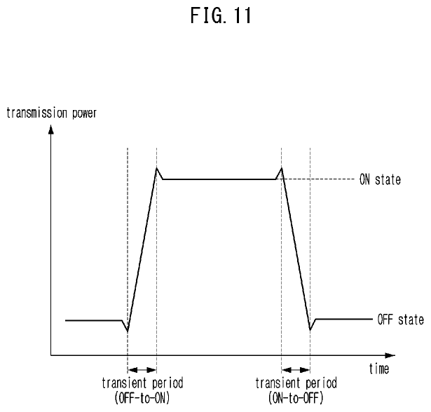

FIG. 11 is a graph illustrating a change in transmission power during a transition between an ON state and an OFF state.

Referring to FIG. 11, a transmitter of a communication node (e.g., a base station and/or a terminal) may operate in an ON state or an OFF state, a transition operation from the ON state to the OFF state may be performed, and a transition operation from the OFF state to the ON state may be performed. In the present disclosure, the communication node may be interpreted as a base station, a terminal, or both a base station and a terminal depending on context. During a transition between the ON/OFF states, the transmission power of the transmitter may vary. Transmission power may be radiated from each of a transmitter operating in the OFF state (hereinafter, an ‘OFF-state transmitter’) and a transmitter operating in the ON state (hereinafter, an ‘ON-state transmitter’). The transmission power of the ON-state transmitter may be greater than that of the OFF-state transmitter.

Time (e.g., a transition time) may be required to transition from the OFF state to the ON state, and the transition time may be defined as an OFF-to-ON transient period (TP). Time (e.g., a transition time) may also be required to transition from the ON state to the OFF state, and the transition time may be defined as an ON-to-OFF TP. When the OFF-to-ON TP and the ON-to-OFF TP are the same, they may not be distinguished, and may be collectively referred to as a transient period (e.g., TP).

Referring to Tables 25 to 28, a transient period of a terminal may be defined as N_{Tx-Rx}×T_{c} or N_{Rx-Tx}×T_{c}. An actual transient period for the transmitter of the terminal may be less than or equal to N_{Tx-Rx}×T_{c} or N_{Rx-Tx}×T_{c}. In an NR communication system, a transient period for a transmitter of a base station may be less than or equal to 10 μs in FR1 and equal to or less than 3 μs in FR2. When converted into microseconds according to Tables 25 to 28, a transient period for a transmitter of a terminal may be less than or equal to 13 μs in FR1 and less than or equal to 7 μs in FR2. In FR1, a transient period for a transmitter of a terminal (e.g., 13 μs) may be understood as a sum of a transient period for a transmitter of a base station (e.g., 10 μs) and a requirement for phase synchronization accuracy between different base stations (e.g., 3 μs). In FR2, a transient period for a transmitter of a terminal (e.g., 7 μs) may be understood as a sum of a transient period for a transmitter of a base station (e.g., 3 μs), a requirement for phase synchronization accuracy between different base stations (e.g., 4 μs), and a margin of 1 μs.

The base station may set N_{TA,offset} of Equation 5 to 13 μs or 7 μs. Alternatively, the base station may not set N_{TA,offset} of Equation 5 or may set N_{TA,offset} to 0. Based on the setting of N_{TA,offset}, the base station may further adjust the value T_{TA} by considering transient periods of the base station and/or the terminal.

For a terminal that does not support simultaneous transmission and reception (e.g., simultaneous uplink communication and downlink communication), a transient period may be applied during a transition between uplink (e.g., uplink communication) and downlink (e.g., downlink communication). The transient period may be applied for transition between uplink and downlink in a half-duplex (HD) terminal that does not support simultaneous transmission and reception in multi-carrier operations such as dual connectivity (DC), carrier aggregation (CA), and supplementary UL (SUL). The transient period may also be applied for transition between uplink and downlink at a downlink-to-uplink boundary and/or an uplink-to-downlink boundary within a TDD carrier.

In a 5G system (e.g., a 5G-Advanced system) and a 6th generation radio (6GR) system, subband full duplex (SBFD), in-band full duplex (IBFD), multiple-transmission and reception points (multi-TRP), non-terrestrial network (NTN), and the like may be supported. In such environments, various methods (e.g., dynamic methods, flexible methods) for direction transition between uplink and downlink may be required. Accordingly, methods for determining and/or applying a new transient period are required.

### [Method for Determining a Transient Period Considering Duplex Schemes]

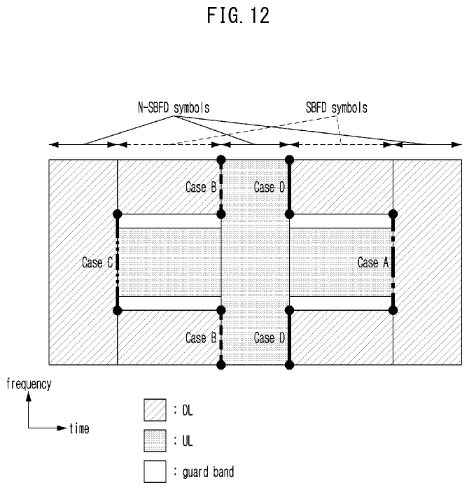

FIG. 12 is a conceptual diagram illustrating a transition between uplink and downlink based on an SBFD configuration.

Referring to FIG. 12, among consecutive symbols in a carrier to which SBFD is applied, some symbols may be configured as non-SBFD (N-SBFD) symbols (e.g., TDD symbols). N-SBFD symbols may be used as downlink (DL) symbols, uplink (UL) symbols, or flexible (FL) symbols. Symbols other than the N-SBFD symbols may be configured as SBFD symbols. A frequency band of SBFD symbols may include a DL subband (e.g., an SBFD DL subband, a DL usable subband) and a UL subband (e.g., an SBFD UL subband, a UL usable subband).

Depending on a type of signal allocated to an SBFD symbol (e.g., an uplink signal or a downlink signal), the SBFD symbol may be used for uplink communication or downlink communication. In the present disclosure, an uplink signal may refer to an uplink signal, an uplink channel, or both an uplink signal and channel, and a downlink signal may refer to a downlink signal, a downlink channel, or both a downlink signal and channel depending on context.

In the exemplary embodiment of FIG. 12, four cases for transition between uplink and downlink may exist as shown in Table 31 below.

TABLE 31

| | | Operation of a |
|---|---|---|
| | | transmitter of a |
| | Frequency regions | base station |
| | for transition | during transition |
| Case A (SBFD → DL) | SBFD UL subband | OFF-to-ON transition |
| | and guard band(s) | |
| Case B (SBFD → UL) | SBFD DL subband | ON-to-OFF transition |
| Case C (DL → SBFD) | SBFD UL subband | ON-to-OFF transition |
| | and guard band(s) | |
| Case D (UL → SBFD) | SBFD DL subband | OFF-to-ON transition |

A base station (e.g., a transmitter of the base station) may perform operations defined in Table 31 for each case, considering transient period conditions (e.g., ≤10 μs in FR1 and ≤3 μs in FR2). A terminal supporting SBFD (hereinafter, an ‘SBFD terminal’) may be an HD terminal and may operate based on methods for ensuring a transient period (e.g., N_{TA,offset}).

When considering new duplex schemes (e.g., IBFD) in next-generation communication systems, cases may be classified depending on whether a communication node (e.g., a base station and/or a terminal) has full duplex (FD) capability as follows.
Case 1: The base station does not have FD capability in a TDD carrier
Case 2: The base station has FD capability in a TDD carrier
Case α: The terminal does not have FD capability in a TDD carrier
Case β: The terminal has FD capability in a TDD carrier

When a pair of a base station and a terminal is configured based on Case 1, Case 2, Case α, and/or Case β, the following scenarios may be defined.
Scenario 1-α (TDD): Both the base station and the terminal may not have FD capability. Scenario 1-α (TDD) may correspond to a conventional TDD scenario. In Scenario 1-α (TDD), a method for at least one of a transient period of the base station (e.g., a BS transient period) or a transient period of the terminal (e.g., a UE transient period) may be used.
Scenario 1-β (5G network+6G UE): The base station may not have FD capability, and the terminal may have FD capability. Scenario 1-β may include a case in which a 6G terminal accesses a 5G network (e.g., a 5G base station). A BS transient period may be guaranteed based on one of the above-described methods, and a UE transient period may be guaranteed based on one of the methods described below.
Scenario 2-α (SBFD): The base station may have FD capability, and the terminal may have half-duplex (HD) capability. That is, the terminal may not have FD capability. Scenario 2-α may correspond to a scenario in which SBFD is applied. A transient period (e.g., an SBFD transient period) may be guaranteed based on one of the above-described methods. Alternatively, a transient period (e.g., an SBFD transient period) may be guaranteed based on one of the methods described below.
Scenario 2-β (FD): Both the base station and the terminal may have FD capability. A transient period may be guaranteed based on one of the methods described below.

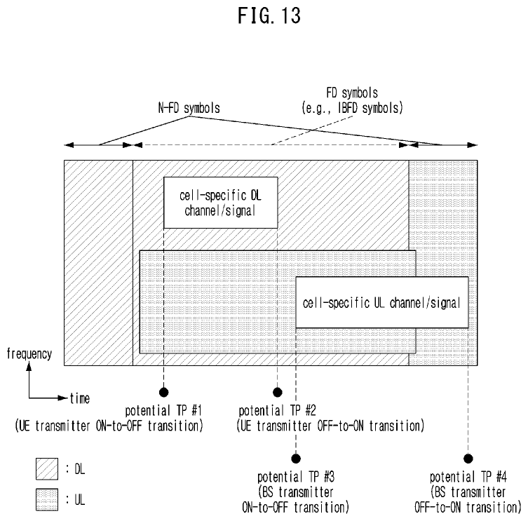

FIG. 13 is a conceptual diagram illustrating a transition between uplink and downlink based on an FD configuration.

Referring to FIG. 13, among consecutive symbols in a carrier to which FD is applied, some symbols may be configured as N-FD symbols (e.g., TDD symbols). N-FD symbols may be used as DL symbols, UL symbols, or FL symbols. Symbols other than the N-FD symbols may be configured as FD symbols. An FD symbol may indicate an in-band full duplex (IBFD) symbol. A frequency band of FD symbols may include a DL subband (e.g., an FD DL subband or a DL usable subband) and a UL subband (e.g., an FD UL subband or a UL usable subband). Depending on a type of signal allocated to an FD symbol (e.g., an uplink signal or a downlink signal), the FD symbol may be used for uplink communication or downlink communication. In an FD scenario, a base station and a terminal may perform simultaneous transmission and reception in an FD symbol. Accordingly, a constraint on a transient period may be relaxed.

A communication node may apply (e.g., configure) a transient period (TP) at a start portion (e.g., a start time) and/or an end portion (e.g., an end time) of a specific channel or signal within a period composed of FD symbol(s). The transient period may represent a potential transient period. In the present disclosure, applying a transient period may indicate configuring a TA offset, a time offset, a guard period, a gap, or a combination thereof in order to guarantee the transient period.

The specific channel or signal may include at least one of a synchronization signal block (SSB), a control channel and a data channel for transmitting system information block 1 (SIB1), a tracking reference signal (TRS) (e.g., a reference signal for time tracking and/or frequency tracking), a downlink channel or signal for a handover procedure, a downlink channel or signal for a paging procedure, or a cell-specific downlink channel or signal. The base station may instruct (e.g., configure) the terminal to perform an ON-to-OFF transition operation of a UE transmitter at a start time (e.g., a start symbol or a start slot) of a cell-specific downlink channel or signal in order to ensure reception performance of the cell-specific downlink channel or signal at the terminal. The terminal may perform the ON-to-OFF transition operation of the UE transmitter at the start time of the cell-specific downlink channel or signal based on the instruction (e.g., configuration) of the base station. Alternatively, performing the ON-to-OFF transition operation of the UE transmitter at the start time (e.g., start symbol, start slot) of the cell-specific downlink channel or signal by the terminal may be allowed (or mandated) in the technical specifications.

The base station may inform the terminal, through signaling, that the base station performs an OFF-to-ON transition operation of a BS transmitter at the start time of the cell-specific downlink channel or signal in order to ensure a transmission period of the cell-specific downlink channel or signal. Alternatively, performing the OFF-to-ON transition operation of the BS transmitter at the start time of the cell-specific downlink channel or signal by the base station may be allowed (or mandated) in the technical specifications.

The base station may instruct (e.g., configure) the terminal to perform an OFF-to-ON transition operation of a UE transmitter at an end time (e.g., an end symbol or an end slot) of the cell-specific downlink channel or signal in order to release focus on reception of the cell-specific downlink channel or signal and to perform (resume) FD operations of the terminal. The terminal may perform the OFF-to-ON transition operation of the UE transmitter at the end time of the cell-specific downlink channel or signal based on the instruction (e.g., configuration) of the base station. Alternatively, performing the OFF-to-ON transition operation of the UE transmitter at the end time (e.g., an end symbol, an end slot) of the cell-specific downlink channel or signal by the terminal may be allowed (or mandated) in the technical specifications.

The base station may inform the terminal, through signaling, that the base station performs an ON-to-OFF transition operation of a BS transmitter at an end time of the cell-specific downlink channel or signal based on ensuring a transmission period of the cell-specific downlink channel or signal. Alternatively, performing the ON-to-OFF transition operation of the BS transmitter at the end time of the cell-specific downlink channel or signal by the base station may be allowed (or mandated) in the technical specifications.

In another exemplary embodiment, the specific channel or signal may include at least one of an uplink channel or signal for a random access channel (RACH) procedure (e.g., Msg1, Msg3, or Msg4 ACK), an uplink channel or signal for a handover procedure, an uplink channel or signal for a paging procedure, or a cell-specific uplink channel or signal. The base station may inform the terminal, through signaling, that the base station performs an ON-to-OFF transition operation of a BS transmitter at a start time (e.g., start symbol, start slot) of the cell-specific uplink channel or signal in order to ensure reception performance of the cell-specific uplink channel or signal. Alternatively, performing the ON-to-OFF transition operation of the BS transmitter at the start time (e.g., start symbol, start slot) of the cell-specific uplink channel or signal by the base station may be allowed (or mandated) in the technical specifications.

The base station may instruct (e.g., configure) the terminal to perform an OFF-to-ON transition operation of a UE transmitter at a start time of the cell-specific uplink channel or signal in order to ensure a transmission period of the cell-specific uplink channel or signal. The terminal may perform the OFF-to-ON transition operation of the UE transmitter at the start time of the cell-specific uplink channel or signal based on the instruction (e.g., configuration) of the base station. Alternatively, performing the OFF-to-ON transition operation of the UE transmitter at the start time of the cell-specific uplink channel or signal by the terminal may be allowed (or mandated) in the technical specifications.

The base station may inform the terminal, through signaling, that the base station performs an OFF-to-ON transition operation of a BS transmitter at an end time (e.g., end symbol, end slot) of the cell-specific uplink channel or signal in order to release focus on reception of the cell-specific uplink channel or signal and to perform (e.g., resume) FD operations of the base station. Alternatively, performing the OFF-to-ON transition operation of the BS transmitter at the end time (e.g., end symbol, end slot) of the cell-specific uplink channel or signal by the base station may be allowed (or mandated) in the technical specifications.

The base station may instruct (e.g., configure) the terminal to perform an ON-to-OFF transition operation of a UE transmitter at an end time of a cell-specific uplink channel or signal based on ensuring a transmission period of the cell-specific uplink channel or signal. The terminal may perform the ON-to-OFF transition operation of the UE transmitter at the end time of the cell-specific uplink channel or signal based on the instruction (e.g., configuration) of the base station. Alternatively, performing the ON-to-OFF transition operation of the UE transmitter at the end time of the cell-specific uplink channel or signal by the terminal may be allowed (or mandated) in the technical specifications.
Method 1-1: applying a transient period at a start time and/or an end time of each of a cell-common downlink channel/signal and a cell-common uplink channel/signal
Method 1-2: applying a transient period within an explicitly defined uplink transmission dormancy period (e.g., within a dormancy period) and applying a transient period at a boundary of the uplink transmission dormancy period
Method 1-3: a network (e.g., a base station) may recognize that a terminal does not need to apply a transient period

### [Method for Determining a Transient Period Based on a UL/DL Dormancy Period]

For the purpose of reducing power consumption of a terminal, a period (e.g., a time period, a time-frequency period, or a time-frequency-space period) in which a transmitter of the terminal is in an OFF state as a default state may be allocated (e.g., configured). In the present disclosure, a period in which the transmitter of the terminal is in an OFF state as a default state may be defined as a UL dormancy period. The UL dormancy period may be referred to as a UL transmission power saving period, a UE transmitter deactivation period, a UE transmitter dormancy period, or the like.

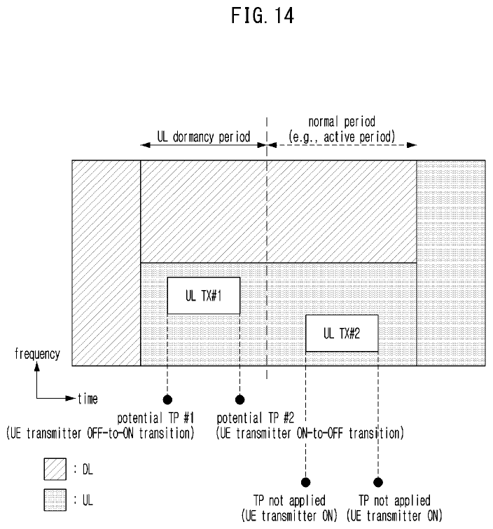

FIG. 14 is a conceptual diagram illustrating a transient period of a UE transmitter based on the allocation of a UL dormancy period.

Referring to FIG. 14, a base station may configure some of uplink resources allocated to a terminal as a UL dormancy period. Remaining uplink resources not configured as the UL dormancy period may be interpreted as a normal period (e.g., an active period) in which a terminal transmitter (e.g., a UE transmitter) does not operate in a dormant state (e.g., a deactivated state). The base station may transmit configuration information of the UL dormancy period to the terminal through signaling. The terminal may identify the configuration information of the UL dormancy period through signaling from the base station, and may identify the UL dormancy period based on the configuration information.

The base station may instruct (e.g., configure) the terminal to apply a transient period of a UE transmitter at a start time and/or an end time of an uplink channel/signal transmission UL TX #1 within the UL dormancy period. In other words, the base station may transmit, to the terminal, configuration information of transient period(s) for the uplink channel/signal transmission UL TX #1 within the UL dormancy period. The configuration information of transient period(s) may include at least one of information indicating the length of the transient period(s), information indicating whether a transient period is configured at the start time of the uplink channel/signal transmission UL TX #1, or information indicating whether a transient period is configured at the end time of the uplink channel/signal transmission UL TX #1. The terminal may apply a transient period to the UE transmitter at the start time and/or the end time of the uplink channel/signal transmission UL TX #1 within the UL dormancy period based on the instruction (e.g., configuration) of the base station. Alternatively, applying a transient period of the UE transmitter at the start time and/or the end time of the uplink channel/signal transmission (UL TX #1) within the UL dormancy period by the terminal may be allowed (or mandated) in the technical specifications. In the present disclosure, a transient period of the UE transmitter may be referred to as a UE transmitter transient period.

The terminal may transition the state of the UE transmitter from an OFF state to an ON state in the transient period before the start time of the uplink channel/signal transmission UL TX #1, and may perform uplink channel/signal transmission UL TX #1 using the transmitter in the ON state. When the uplink channel/signal transmission UL TX #1 is completed, the terminal may transition the state of the UE transmitter from the ON state to the OFF state in the transient period after the end time of the uplink channel/signal transmission UL TX #1. When a transient period is not configured at the end time of the uplink channel/signal transmission UL TX #1, the terminal may transition the state of the UE transmitter from the ON state to the OFF state after completion of the uplink channel/signal transmission UL TX #1 when no other uplink transmission is present.

The terminal may not perform any other uplink transmission within the UE transmitter transient period. The terminal may drop or suspend an uplink transmission overlapping with the UE transmitter transient period. For example, the terminal may not perform another uplink transmission in the transient period before the uplink channel/signal transmission UL TX #1, and may perform or may not perform another uplink transmission in the transient period after the uplink channel/signal transmission UL TX #1. When another uplink transmission is performed in the transient period after the uplink channel/signal transmission UL TX #1, the transient period may be reconfigured (e.g., updated).

The base station may instruct (e.g., configure) the terminal not to apply a UE transmitter transient period at the start time and/or the end time of the uplink channel/signal transmission UL TX #2 within a normal period (e.g., an active period). The terminal may not apply a UE transmitter transient period at the start time and/or the end time of the uplink channel/signal transmission UL TX #2 within a normal period based on the instruction (e.g., configuration) of the base station. Alternatively, not applying the UE transmitter transient period at the start time and/or the end time of the uplink channel/signal transmission UL TX #2 within the normal period by the terminal may be allowed (or mandated) in the technical specifications. The terminal may perform the uplink channel/signal transmission UL TX #2 without configuration (e.g., application) of a transient period within the normal period. When an uplink transmission overlapping with the UE transmitter transient period is present within the normal period, the terminal may perform the uplink transmission unless a separate drop rule and/or priority rule exists.

A situation may occur in which a change to the UE transmitter transient period is required. In this case, the base station may transmit change information (e.g., update information) of the UE transmitter transient period to the terminal through signaling. The terminal may receive the change information (e.g., update information) of the UE transmitter transient period through signaling from the base station, and may update the UE transmitter transient period based on the change information. For example, based on the update, the length of the UE transmitter transient period may decrease or increase.

Based on the above-described exemplary embodiment, a communication node may guarantee a dormant state of a UE transmitter within a UL dormancy period, and may control the UE transmitter to transition to an active state when necessary to perform uplink transmission.

### UL Dormancy Period for Turning Off a UE Power Amplifier

During consecutive uplink symbols and slots, a base station may allocate a UL dormancy period to one or more terminals (e.g., a set of terminals), and when the base station does not configure (e.g., indicate) an uplink channel/signal within the UL dormancy period, a terminal may turn off a power amplifier of the terminal.

For an uplink channel/signal overlapping with the UL dormancy period, the base station and/or the terminal may apply a UE transient period (e.g., a UE transmitter transient period) for the uplink channel/signal. For an uplink channel/signal not overlapping with the UL dormancy period, the base station and/or the terminal may not apply a UE transient period (e.g., a UE transmitter transient period) for the uplink channel/signal.

The UL dormancy period may be defined based on at least one of a start system frame number (SFN), a start slot, a start symbol, an SFN duration, a slot duration, a symbol duration, an end SFN, an end slot, or an end symbol. In other words, configuration information of the UL dormancy period may include at least one of a start SFN, a start slot, a start symbol, an SFN duration, a slot duration, a symbol duration, an end SFN, an end slot, or an end symbol.

For the purpose of reducing power consumption of the base station, a period (e.g., a time period, a time-frequency period, or a time-frequency-space period) in which a transmitter of the base station is in an OFF state as a default state may be allocated (e.g., configured). In the present disclosure, a period in which the transmitter of the base station is in an OFF state as a default state may be defined as a DL dormancy period. The DL dormancy period may be referred to as a DL transmission power saving period, a BS transmitter deactivation period, a BS transmitter dormancy period, or the like.

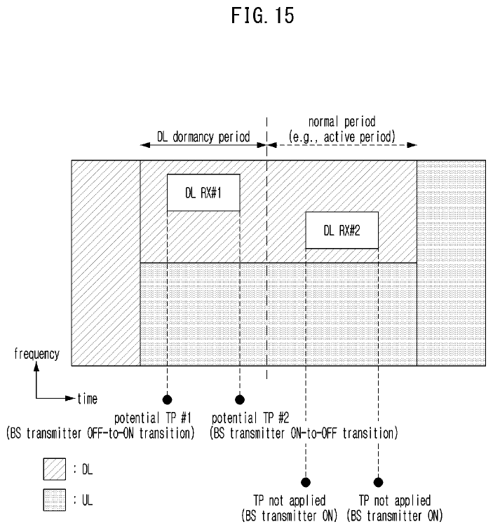

FIG. 15 is a conceptual diagram illustrating a transient period of a BS transmitter based on the allocation of a DL dormancy period.

Referring to FIG. 15, a base station may configure some of downlink resources allocated to a terminal as a DL dormancy period. Remaining downlink resources not configured as the DL dormancy period may be interpreted as a normal period (e.g., an active period) in which a base station transmitter (e.g., a BS transmitter) does not operate in a dormant state (e.g., a deactivated state). The base station may transmit configuration information of the DL dormancy period to the terminal through signaling. The terminal may identify the configuration information of the DL dormancy period through signaling from the base station, and may identify the DL dormancy period based on the configuration information.

The base station may inform the terminal, through signaling, that a BS transmitter transient period is applied at a start time and/or an end time of a downlink channel/signal reception DL RX #1 within the DL dormancy period. In other words, the base station may transmit, to the terminal, configuration information of transient period(s) for the downlink channel/signal reception DL RX #1 within the DL dormancy period. The configuration information of transient period(s) may include at least one of information indicating the length of the transient period(s), information indicating whether a transient period is configured at the start time of the downlink channel/signal reception DL RX #1, or information indicating whether a transient period is configured at the end time of the downlink channel/signal reception DL RX #1. The terminal may identify that a BS transmitter transient period is applied at the start time and/or the end time of the downlink channel/signal reception DL RX #1 based on signaling from the base station. Alternatively, applying a BS transmitter transient period at the start time and/or the end time of the downlink channel/signal reception DL RX #1 within the DL dormancy period by the base station may be allowed (or mandated) in the technical specifications. The terminal may perform downlink channel/signal reception by considering the transient period indicated by the base station. In the present disclosure, a transient period of the BS transmitter may be referred to as a BS transmitter transient period.

The base station may transition the state of the BS transmitter from the OFF state to the ON state in the transient period before the start time of the downlink channel/signal transmission DL TX #1 or DL RX #1, and may perform downlink channel/signal transmission DL TX #1 or DL RX #1 using the BS transmitter in the ON state. When the downlink channel/signal transmission DL TX #1 or DL RX #1 is completed, the base station may transition the state of the BS transmitter from the ON state to the OFF state in the transient period after the end time of the downlink channel/signal transmission DL TX #1 or DL RX #1. When a transient period is not configured at the end time of the downlink channel/signal transmission DL TX #1 or DL RX #1, the base station may transition the state of the BS transmitter from the ON state to the OFF state after completion of the downlink channel/signal transmission DL TX #1 or DL RX #1 when no other downlink transmission is present.

The base station may not perform any other downlink transmission within the BS transmitter transient period. The base station may drop or suspend a downlink transmission overlapping with the BS transmitter transient period. For example, the base station may not perform another downlink transmission in the transient period before the downlink channel/signal transmission DL TX #1 or DL RX #1, and may perform or may not perform another downlink transmission in the transient period after the downlink channel/signal transmission DL TX #1 or DL RX #1. When another downlink transmission is performed in the transient period after the downlink channel/signal transmission DL TX #1 or DL RX #1, the transient period may be reconfigured (e.g., updated).

When a TRP transmitting a downlink channel/signal based on a TCI (or quasi-co-location (QCL)) of a downlink channel/signal overlapping with a BS transmitter transient period is determined to be different from a TRP to which the BS transmitter transient period is applied, a terminal capable of receiving the downlink channel/signal may determine that the BS transmitter transient period is not applied at a start time and/or an end time of a downlink channel/signal reception DL RX #2 within a normal period. In other words, the base station may inform the terminal, through signaling, that the BS transmitter transient period is not applied at the start time and/or the end time of the downlink channel/signal reception DL RX #2 within the normal period. Alternatively, not applying the BS transmitter transient period at the start time and/or the end time of the downlink channel/signal reception DL RX #2 within a normal period may be allowed (or mandated) in the technical specifications. The base station may perform the downlink channel/signal transmission DL RX #2 or DL TX #2 without configuring (or applying) a transient period within a normal period. When a downlink transmission overlapping with the BS transmitter transient period is present within a normal period, the base station may perform the downlink transmission unless a separate drop rule and/or priority rule exists.

A situation may occur in which the BS transmitter transient period needs to be changed. In this case, the base station may transmit change information (e.g., update information) of the BS transmitter transient period to the terminal through signaling. The terminal may receive the change information (e.g., update information) of the BS transmitter transient period through signaling from the base station, and may update the BS transmitter transient period based on the change information. For example, based on the update, the length of the BS transmitter transient period may decrease or increase. The terminal may perform downlink channel/signal reception by considering the updated BS transmitter transient period.

Based on the above-described exemplary embodiment, a communication node may guarantee a dormant state of a BS transmitter within a DL dormancy period, and may control the BS transmitter to transition to an active state when necessary to perform downlink transmission.

### DL Dormancy Period for Turning Off a BS Power Amplifier

During consecutive downlink symbols and slots, a base station may allocate a DL dormancy period to one or more terminals (e.g., a set of terminals), and when the base station does not configure (e.g., indicate) a downlink channel/signal within the DL dormancy period, the base station may turn off a power amplifier of the base station.

For a downlink channel/signal overlapping with the DL dormancy period, the base station and/or a terminal may apply a BS transient period (e.g., a BS transmitter transient period) for the downlink channel/signal. For a downlink channel/signal not overlapping with the DL dormancy period, the base station and/or the terminal may not apply a BS transient period (e.g., a BS transmitter transient period) for the downlink channel/signal. Applying a BS transient period by the terminal may indicate that the terminal performs a reception operation of a downlink channel/signal by considering the BS transient period. Not applying a BS transient period by the terminal may indicate that the terminal performs a reception operation of a downlink channel/signal without considering the BS transient period.

The DL dormancy period may be defined based on at least one of a start SFN, a start slot, a start symbol, an SFN duration, a slot duration, a symbol duration, an end SFN, an end slot, or an end symbol. In other words, configuration information of the DL dormancy period may include at least one of a start SFN, a start slot, a start symbol, an SFN duration, a slot duration, a symbol duration, an end SFN, an end slot, or an end symbol.

Depending on whether a communication node supports FD and whether power/energy saving is supported, various types of DL/UL dormancy periods may be applied as follows.
Type-0: a DL/UL dormancy period may be applied to a base station and a terminal.
Type-1: a DL/UL dormancy period may be applied only to a base station.
Type-2: a DL/UL dormancy period may be applied only to a terminal.

The base station may indicate, through signaling, one type of DL/UL dormancy period to the terminal. The terminal may identify the type of the DL/UL dormancy period indicated by signaling from the base station. In the present disclosure, signaling may include at least one of SI signaling (e.g., SIB), RRC signaling, MAC signaling (e.g., MAC CE), or PHY signaling (e.g., DCI). Alternatively, the terminal may transmit a UE capability report to the base station. The base station may receive the UE capability report from the terminal, and may identify information on the type of the DL/UL dormancy period based on the UE capability report. In other words, the UE capability report may include information on the type of the DL/UL dormancy period.

### [Method for Determining a Transient Period Based on Multi-Radio Access Technology (RAT) or Multi-Carrier]

A communication node (e.g., a base station and/or a terminal) may allocate (e.g., configure), for the purpose of reducing power consumption, a frequency resource (e.g., a frequency band) in which a transmitter of the communication node is in an ON state as a default state. In the present disclosure, a frequency resource in which the transmitter of the communication node is in an ON state as a default state may be defined as an anchor carrier (or a main carrier). The anchor carrier may be referred to as a reference carrier, a root carrier, an always-ON carrier, or the like. In an additional carrier (e.g., a secondary carrier) other than the anchor carrier, a state in which the transmitter of the communication node is in an OFF state may be interpreted as a default state. The above-described exemplary embodiment may be applied to a cell, a cell group (CG), a component carrier (CC), a BWP, or the like. The following exemplary embodiment will be described based on a carrier, but the following exemplary embodiment may be applied to a cell, a CG, a CC, or a BWP.

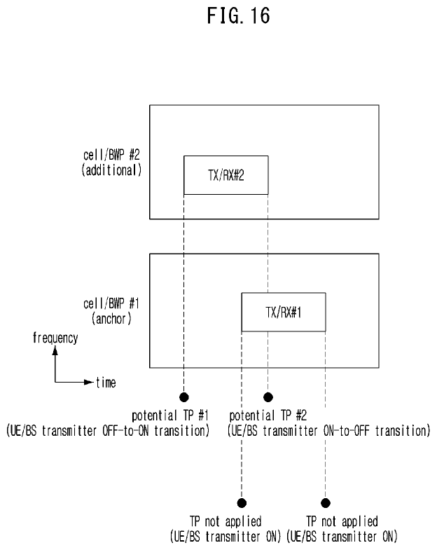

FIG. 16 is a conceptual diagram illustrating a transmitter transient period of a UE or a BS in a multi-carrier operation.

Referring to FIG. 16, a base station may allocate (e.g., configure) two or more frequency resources to a terminal. The two or more frequency resources may include Cell #1 and Cell #2 (or BWP #1 and BWP #2). A first frequency resource may be an anchor carrier, and a default state of a transmitter of a communication node may be an ON state in the anchor carrier. A second frequency resource may be an additional carrier, and a default state of the transmitter of the communication node may be an OFF state in the additional carrier.

For transmission or reception TX/RX #2 of a channel or signal in the additional carrier, the communication node may determine that a transient period is applied for an OFF-to-ON transition of the transmitter of the communication node at a start portion (e.g., a start time) of the channel or signal, and may determine that a transient period is applied for an ON-to-OFF transition of the transmitter of the communication node at an end portion (e.g., an end time) of the channel or signal. In order to support the above-described operation, one of the exemplary embodiments of the present disclosure may be applied.

The communication node may determine that OFF-to-ON transition and/or ON-to-OFF transition does not occur in the anchor carrier since the transmitter of the communication node is always in the ON state in the anchor carrier. For transmission or reception TX/RX #1 of a channel or signal in the anchor carrier, not applying a transient period (e.g., a transient period of the transmitter of the communication node) other than a TDD transient period may be indicated (e.g., configured) to the communication node. Alternatively, not applying a transient period (e.g., a transient period of the transmitter of the communication node) other than a TDD transient period for transmission or reception TX/RX #1 of a channel or signal in the anchor carrier may be defined (or mandated) in the technical specifications.

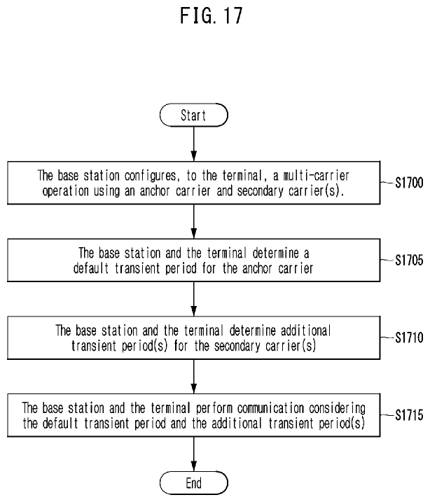

FIG. 17 is a flowchart illustrating an operation of a communication node in a multi-carrier.

Referring to FIG. 17, a base station may configure, to a terminal, a multi-carrier operation using an anchor carrier and one or more secondary carriers (S1700). In other words, the base station may transmit, to the terminal through signaling, configuration information for the multi-carrier operation. The terminal may receive the configuration information for the multi-carrier operation through signaling from the base station.

The communication node (e.g., the base station and/or the terminal) may determine a default transient period for the anchor carrier (S1705). The default transient period may be determined based on the configuration information for the multi-carrier operation transmitted and received in step S1700. The communication node may determine an additional transient period for each of one or more secondary carriers by considering power or energy saving (S1710). The communication node may perform uplink communication and/or downlink communication by considering the default transient period determined in step S1705 and/or the additional transient period determined in step S1710 (S1715).

The transient period may be configured for each of a RAT, a CG, a CC, or a BWP. ON-to-OFF transition and/or OFF-to-ON transition for a BS or UE transmitter may not be performed in an anchor resource (e.g., a resource within the anchor carrier). A default state of the BS or UE transmitter in other resources may be an OFF state.

[Method for Determining a Transient Period Based on a Type of a Terminal, a Base Station, a Service, and/or a Network]

A communication node (e.g., a base station and/or a terminal) may determine a transient period based on a type of the terminal, a service scenario, or a network structure. For example, the communication node may determine (e.g., configure or apply) a default transient period for a terminal accessing a terrestrial network (TN) based on one of the above-described exemplary embodiments. The default transient period may have a length of X μs. X may be a natural number. When a terminal having a GNSS function accesses an NTN, the communication node may determine (e.g., configure or apply) an additional transient period (e.g., X+a μs) obtained by adding a first margin (e.g., a μs) to the default transient period. In other words, applying the additional transient period obtained by adding the first margin to the default transient period may be indicated (e.g., configured) to the communication node. Alternatively, applying the additional transient period obtained by adding the first margin to the default transient period may be allowed (or mandated) in the technical specifications.

When a terminal not having a GNSS function (e.g., a low-cost terminal) accesses an NTN, when a terminal having low GNSS accuracy (e.g., a low-power terminal) accesses an NTN, or when a terminal accesses an NTN in an unfavorable environment, the communication node may determine (e.g., configure or apply) a relaxed additional transient period (e.g., X+a+b μs) obtained by adding a second margin (e.g., b μs) to the additional transient period (e.g., X+a μs). In other words, applying the relaxed additional transient period obtained by adding the second margin to the additional transient period may be indicated (e.g., configured) to the communication node. Alternatively, applying the relaxed additional transient period obtained by adding the second margin to the additional transient period may be allowed (or mandated) in the technical specifications.

The transient period may be configured for each terminal type and/or service type. A length of the default transient period for a TN may be configured as X μs. A length of the additional transient period for an NTN having a GNSS function may be configured as X+a μs. A length of the relaxed additional transient period for an NTN not having a GNSS function may be configured as X+a+b μs.

In an exemplary embodiment, an execution order of steps may not be limited to an execution order described in the present disclosure. A plurality of steps may be performed simultaneously, execution of some step(s) may be omitted, other step(s) may be additionally performed, and steps may be performed in a different order. The exemplary embodiments of the present disclosure may be performed independently. Alternatively, a combination of exemplary embodiments of the present disclosure may be applied.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, configuration information of an uplink (UL) dormancy period in which a default state of a transmitter of the terminal is an OFF state;
determining one or more transient periods for uplink transmission within the UL dormancy period;
transitioning a state of the transmitter from the OFF state to an ON state in a first transient period among the one or more transient periods, the first transient period being prior to the uplink transmission; and
performing the uplink transmission using the transmitter in the ON state.

2. The method of claim 1, further comprising: after completing the uplink transmission, transitioning the state of the transmitter from the ON state to the OFF state in a second transient period among the one or more transient periods, the second transient period being after the uplink transmission.

3. The method of claim 1, further comprising: after completing the uplink transmission, transitioning the state of the transmitter from the ON state to the OFF state based on no other uplink transmission being present.

4. The method of claim 1, wherein the terminal does not perform another uplink transmission within the first transient period.

5. The method of claim 1, further comprising: receiving, from the base station, information indicating a configuration for the one or more transient periods,
wherein the one or more transient periods are configured based on an instruction from the base station.

6. The method of claim 1, further comprising: performing uplink transmission without configuring a transient period in a normal period in which the default state of the transmitter is the ON state.

7. The method of claim 1, further comprising:
receiving, from the base station, change information for the one or more transient periods; and
updating the one or more transient periods based on the change information.

8. A method of a base station, comprising:
transmitting, to a terminal, configuration information of a downlink (DL) dormancy period in which a default state of a transmitter of the base station is an OFF state;
determining one or more transient periods for downlink transmission within the DL dormancy period;
transitioning a state of the transmitter from the OFF state to an ON state in a first transient period among the one or more transient periods, the first transient period being prior to the downlink transmission; and
performing the downlink transmission using the transmitter in the ON state.

9. The method of claim 8, further comprising: after completing the downlink transmission, transitioning the state of the transmitter from the ON state to the OFF state in a second transient period among the one or more transient periods, the second transient period being after the downlink transmission.

10. The method of claim 8, further comprising: after completing the downlink transmission, transitioning the state of the transmitter from the ON state to the OFF state based on no other downlink transmission being present.

11. The method of claim 8, wherein the base station does not perform another downlink transmission within the first transient period.

12. The method of claim 8, further comprising: transmitting, to the terminal, information indicating the one or more transient periods for the downlink transmission.

13. The method of claim 8, further comprising: performing downlink transmission without configuring a transient period in a normal period in which the default state of the transmitter is the ON state.

14. The method of claim 8, further comprising: transmitting, to the terminal, change information for the one or more transient periods,
wherein the one or more transient periods are updated based on the change information.

15. A terminal comprising at least one processor, wherein the at least one processor causes the terminal to perform:
receiving, from a base station, configuration information of an uplink (UL) dormancy period in which a default state of a transmitter of the terminal is an OFF state;
determining one or more transient periods for uplink transmission within the UL dormancy period;
transitioning a state of the transmitter from the OFF state to an ON state in a first transient period among the one or more transient periods, the first transient period being prior to the uplink transmission; and
performing the uplink transmission using the transmitter in the ON state.

16. The terminal of claim 15, wherein the at least one processor further causes the terminal to perform: after completing the uplink transmission, transitioning the state of the transmitter from the ON state to the OFF state in a second transient period among the one or more transient periods, the second transient period being after the uplink transmission.

17. The terminal of claim 15, wherein the at least one processor further causes the terminal to perform: after completing the uplink transmission, transitioning the state of the transmitter from the ON state to the OFF state based on no other uplink transmission being present.

18. The terminal of claim 15, wherein the at least one processor further causes the terminal to perform: receiving, from the base station, information indicating a configuration for the one or more transient periods,
wherein the one or more transient periods are configured based on an instruction from the base station.

19. The terminal of claim 15, wherein the at least one processor further causes the terminal to perform: performing uplink transmission without configuring a transient period in a normal period in which the default state of the transmitter is the ON state.

20. The terminal of claim 15, wherein the at least one processor further causes the terminal to perform:
receiving, from the base station, change information for the one or more transient periods; and
updating the one or more transient periods based on the change information.
